(19) United States
(12) Patent Application Publication
(10) Pub. No.: US 2026/0347135 A1
(43) Pub. Date: Nov. 5, 2026

(54) PAPER SHEET DISCHARGE STACKING DEVICE AND CIRCULATION-TYPE PAPER SHEET PROCESSING DEVICE

(71) Applicant: JAPAN CASH MACHINE CO., LTD., Osaka (JP)

(72) Inventors: Yoshihisa Fujie, Osaka (JP); Keiichi Togano, Osaka (JP)

(73) Assignee: JAPAN CASH MACHINE CO., LTD., Osaka (JP)

(21) Appl. No.: 19/111,612

(22) PCT Filed: Sep. 14, 2023
(86) PCT No.: PCT/JP2023/033584

§ 371 Date: Jan. 6, 2026

(30) Foreign Application Priority Data
Oct. 7, 2022 (JP) 2022-162202

(51) Int. Cl. B65H 29/70; B65H 31/02; G07D 11/17; G07D 11/175

(52) U.S. Cl. CPC B65H 29/70; B65H 31/02; G07D 11/17; G07D 11/175; B65H 2701/1912

(57) ABSTRACT

A a paper sheet discharge stacking device and a circulation-type paper sheet processing device prevents a paper sheet dispensed from a circulation unit from causing a stacking failure on a dispense tray. The device includes a discharge transport route on which paper sheets dispensed from circulation units are transported to a discharge tray with a short side thereof at the head, and a forming mechanism that forms a short side shape of each of the paper sheets transported on the discharge transport route into a predetermined shape across the entire length in a long edge direction and that discharges the formed paper sheet onto the discharge tray.

### FIELD

The present invention relates to a paper sheet discharge stacking device and a circulation-type paper sheet processing device.

### BACKGROUND

As banknote processing devices installed in a banknote handling device that has a function to provide various goods or services upon receipt of an input banknote, such as an automatic vending machine, a game media dispensing machine in a game hall, a ticketing machine, a deposit/dispense device, and a change machine, a circulation type that enables capture, storage, and dispense of plural denominations of banknotes is known.

A circulation-type banknote processing device is equipped with a banknote storage unit for retaining banknotes that are prepared in advance to be dispensed or that are input during the operation according to the denominations or in a state where the denominations are mixed.

As the banknote storage unit, there are a circulation-type banknote storage unit having a function to dispense banknotes as change to outside while storing banknotes, and a collection banknote storage unit (a collection container) that collects all banknotes in a banknote processing device at the closing time or the like.

As the circulation-type banknote storage unit, a type that stores banknotes between tapes wound around the outer circumferential surface of a circulation drum in a helical manner (a spiral manner) to be superimposed one on top of another as a “banknote handling device” described in Patent Literature 1 is known.

The device described in this literature includes only one deposit/dispense unit and input banknotes and banknotes to be output (banknotes for change) are input into and output from the device from this deposit/dispense unit.

When banknotes stacked on the outer circumferential surface of the circulation drum in a superimposed manner with the tape interposed therebetween are to be dispensed as change or the like, the banknotes on the outer circumference of the circulation drum are sent out one by one by rotating the circulation drum in the dispensing direction and feeding the tapes in the dispensing direction, and the banknotes are escrowed on the outer circumferential surface of a banknote retaining drum in a superimposed manner and are then dispensed to the deposit/dispense unit.

A paper sheet processing device described in Patent Literature 2 (Japanese Patent Publication No. 6450041) is configured in such a manner that an outlet for dispensing change is provided separately from an inlet/outlet through which banknotes are deposited or returned, and banknotes are directly dispensed from a circulation-type banknote storage unit to the outlet. When a plurality of banknotes are to be dispensed as change in this configuration, the banknotes are discharged from the circulation-type banknote storage unit one by one to the outlet and the following second and subsequent banknotes are sequentially discharged after a user takes out the first banknote. However, since a long time is required to dispense all banknotes in this type, there is a problem that load on the user increases and the working rate of the device decreases.

Meanwhile, there is also a type that reduces the waiting time of a user by stacking banknotes dispensed one by one from a circulation-type banknote storage unit in a state of being continuously superimposed on a dispense tray provided on an outlet dedicated for dispense, and enabling the banknotes to be taken out collectively from the dispense tray after discharge and stacking of all the banknotes are completed. However, in a circulation-type banknote storage unit including a circulation drum, since banknotes are retained in a state of being wound on the outer circumferential surface of the circulation drum, a curling habit is formed on each of the banknotes along the long edge direction and the curling habit remains also on the dispensed banknotes. Particularly, if banknotes having a curling habit with the shape in the long edge direction warped upward (the central part in the long edge direction is protruded upward and the both end parts decline obliquely) formed thereon are discharged one by one onto a dispense tray, even when rise of the rear end of a previously discharged banknote is suppressed by a banknote holding lever, a stacking failure such as hitting of a downward inclined leading end of the following banknote against the banknote previously stacked to push the banknote to drop out of the dispense tray occurs.

Furthermore, in a case where any of banknotes discharged onto the dispense tray is a so-called crumpled banknote that is significantly decreased in the stiffness (rigidity), the attitude of the banknote on the dispense tray of course causes deterioration in alignment of the following banknotes. That is, a banknote having a sufficient stiffness and being discharged onto the dispense tray falls on the dispense tray while pushing up the banknote holding lever, and is held down by the banknote holding lever after falling. However, a crumpled banknote that is significantly decreased in the stiffness cannot sufficiently push up the banknote holding lever in the process of being discharged, is discharged onto the dispense tray while being buckled, and is finally brought to an abnormal discharged state such as stopped in a state of being buckled in a space between the banknote holding lever and the upper surface of the dispense tray. If the following banknote is discharged in this state, the crumpled banknote discharged in prior thereto becomes an obstacle and the following banknote cannot stop at a normal stacking position.

Therefore, in a case where banknotes for change are discharged and stacked on the dispense tray one by one, it is difficult to stack the banknotes on the dispense tray in an aligned manner.

### CITATION LIST

### Patent Literatures

Patent Literature 1: Japanese Patent Application Laid-open No. 2016-218965
Patent Literature 2: Japanese Patent Publication No. 6450041

### SUMMARY

### Technical Problem

The present invention has been made in view of the above circumstances, and has an object to provide a paper sheet discharge stacking device and a circulation-type paper sheet processing device that prevent occurrence of a stacking failure of paper sheets dispensed from a circulation unit on a dispense tray in the circulation-type paper sheet processing device.

### Solution to Problem

In order to achieve the above object, the present invention provides a paper sheet discharge stacking device that discharges paper sheets dispensed from a circulation unit storing transported paper sheets and dispensing stored paper sheets to outside, one by one onto a discharge tray with a short side of the paper sheet at a head and that stacks the discharged paper sheets, comprising: a discharge transport route on which the paper sheets are transported to the discharge tray; and a forming mechanism that forms a short side shape of each of the paper sheets transported on the discharge transport route into a predetermined shape across an entire length in a long edge direction and that discharges the formed paper sheet onto the discharge tray, wherein upward protruded parts and downward protruded parts are alternately formed along a short side direction of the paper sheets and both end parts of short sides of each of the paper sheets are inclined upward in the forming by the forming mechanism.

### Advantageous Effects of Invention

According to the present invention, it is possible to prevent occurrence of a stacking failure of paper sheets dispensed from a circulation unit on a dispense tray in the circulation-type paper sheet processing device.

### BRIEF DESCRIPTION OF DRAWINGS

FIG. 1 is a vertical sectional view of a paper sheet processing device including a paper sheet discharge stacking device according to one embodiment of the present invention.

FIG. 2 is a perspective view illustrating a configuration of relevant parts of a second unit M2 according to a first embodiment.

FIG. 3 is a front view of a forming mechanism seen from the discharge side.

FIG. 4 is a perspective view of the forming mechanism seen from the discharge side.

FIGS. 5(a) and 5(b) are a front view illustrating a state where a banknote is formed by the forming mechanism in a shape having a predetermined stiffness and an explanatory diagram illustrating a short side shape of a dispense banknote after being formed, and FIG. 5(c) is an explanatory diagram in a case where the short side of a banknote is formed into an M shape.

FIG. 6(a) is a front-side perspective view illustrating a positional relation between a banknote immediately after being discharged from the forming mechanism and an already-stacked banknote, and guide members, and FIG. 6(b) is a perspective view illustrating a shape of a formed banknote.

FIG. 7 is a perspective view illustrating a configuration of the guide member.

FIG. 8 is a vertical sectional view illustrating a configuration of a dispense tray.

FIG. 9 is a flowchart for explaining the outline of a procedure of a change dispensing operation performed by a banknote processing device of the present invention.

FIG. 10 is a lateral vertical sectional view of a conventional discharge transport stacking unit 500P.

FIGS. 11(a) to 11(d) are explanatory diagrams (lateral vertical sectional views) of an operation of the discharge transport stacking unit, sequentially illustrating states until immediately after the leading end of a banknote has passed through the forming mechanism.

FIGS. 12(e) and 12(f) are explanatory diagrams (lateral vertical sectional views) of an operation of a discharge transport stacking unit, illustrating a state immediately before the rear end of a banknote passes the forming mechanism and a state immediately after the passing, and FIGS. 12(g) and 12(h) are explanatory diagrams of an operation procedure performed by blades to drag a banknote backward.

FIGS. 13(i) to 13(l) are explanatory diagrams of an operation procedure performed by the blades to drag a banknote backward.

FIGS. 14(m) to 14(O) are explanatory diagrams of an operation procedure performed by the blades to drag a banknote backward.

FIG. 15 is a partial sectional front view illustrating a state in which a banknote having a stiffness greatly decreased passes the forming mechanism in which the excessively large gaps G2 are set.

FIG. 16 is a front view of relevant parts of a banknote discharge stacking device M2 (a discharge transport stacking unit 800) according to a third embodiment.

FIGS. 17(a) to 17(d) are lateral vertical sectional views for explaining a configuration of the banknote discharge stacking device M2, and a discharging and sweeping operation thereof.

FIGS. 18(e) to 18(h) are lateral vertical sectional views for explaining a configuration of the banknote discharge stacking device M2, and a discharging and sweeping operation performed by the banknote discharge stacking device M2.

FIGS. 19(i) to 19(l) are lateral vertical sectional views for explaining a configuration of the banknote discharge stacking device M2, and a discharging and sweeping operation performed by the banknote discharge stacking device M2.

FIGS. 20(m) to 20(o) are lateral vertical sectional views for explaining a configuration of the banknote discharge stacking device M2, and a discharging and sweeping operation performed by the banknote discharge stacking device M2.

### DESCRIPTION OF EMBODIMENTS

The present invention will be described below in detail with embodiments illustrated in the drawings.

### [Banknote Processing Device]

### <<Overall Configuration>>

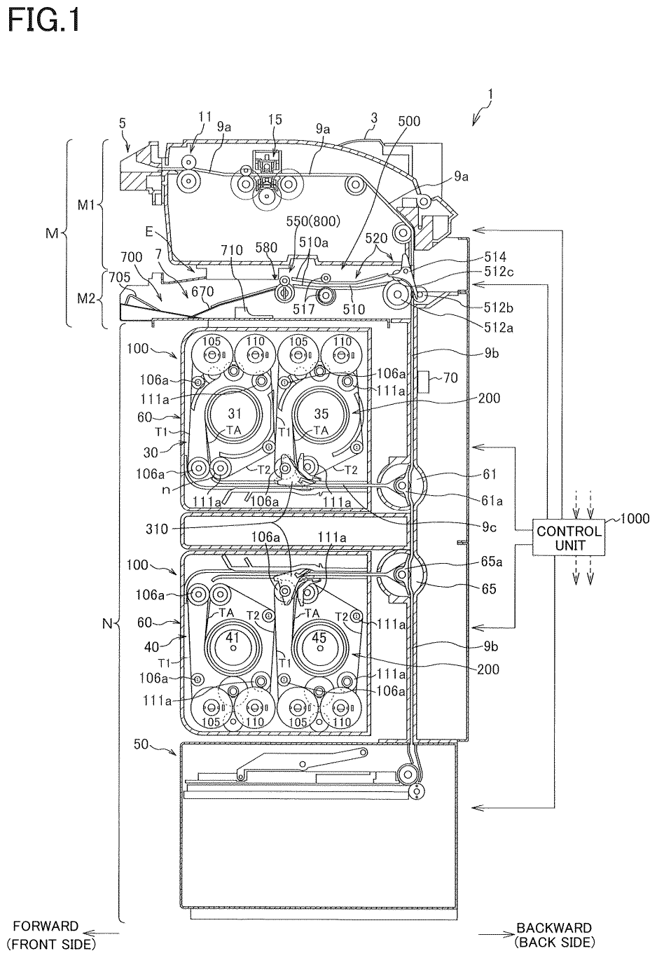

FIG. 1 is a vertical sectional view of a banknote (paper sheet) processing device including a banknote (paper sheet) discharge stacking device according to one embodiment of the present invention.

While a device that processes banknotes as one example of paper sheets is explained in the present embodiment, the paper sheet discharge stacking device and the paper sheet processing device of the present invention can be applied also to a processing device for general paper sheets such as cash vouchers, tickets, and securities other than banknotes. While a quadrangle such as a rectangle and a square, that is, a quadrilateral with four right angles is the main shape of paper sheets in the present embodiment, the paper sheets are not limited to sheets of a quadrilateral with four right angles. A circulation-type banknote processing device (hereinafter, “banknote processing device”) 1 illustrated in FIG. 1 is means that is installed in or provided along with a banknote handling device such as an automatic vending machine, a ticketing machine, a gaming media dispensing machine in a game hall, a deposit/dispense device, or a change machine, and that performs processing of receiving banknotes and dispensing banknotes as change or the like.

The banknote processing device 1 is explained in detail below.

The banknote processing device 1 is generally constituted of a housing 3 that constitutes an exterior body, a deposit/dispense processing unit M that transports banknotes input to the housing in the device or discharges banknotes to the outside of the device on a required route along the long edge direction, a banknote storage unit N that stores banknotes transported from the deposit/dispense processing unit M or that dispenses stored banknotes to the deposit/dispense processing unit M, a transport mechanism that transports banknotes through various routes, and a control unit (a CPU, an MPU, a ROM, a RAM, and the like) 1000 that controls various control targets.

The deposit/dispense processing unit M includes an inlet/outlet (an input port) 5 that receives one banknote or a banknote batch including banknotes of different denominations collectively and that functions as a return port at the time of return of rejected input banknotes, a dispense port (an outlet port) 7 for banknotes that are dispensed as change from the banknote storage unit N, a collective deposit unit (an introduction unit) 11 that individually separates banknotes (a batch) deposited and set at the inlet/outlet 5 and introduces the separated banknote into the device body through a deposited banknote transport route (an introduction part) 9a, a recognition unit 15 that is arranged on a transport route along the deposited banknote transport route 9a and that judges the denomination, authenticity, and the like of a deposited banknote with combined use of an optical or magnetic sensor, and the like.

The deposit/dispense processing unit M is constituted of a first unit M1, and a second unit (a banknote discharge stacking device, a collective dispensing unit) M2.

The first unit M1 includes the inlet/outlet (input port) 5, the deposited banknote transport route 9a, the collective deposit unit 11, the recognition unit 15, an escrow unit (a temporarily retaining unit, not illustrated) that escrows deposited banknotes passing through the recognition unit until the number of the banknotes reaches a predetermined number and that feeds the banknotes to storage units 30 and 40 and a collection container 50 (which will be described later) when receiving of the banknotes is confirmed, and that feeds the banknotes to a dispense stacking unit (not illustrated) at the time of cancellation return by a return request or the like, the dispense stacking unit (a stacker for return banknotes, not illustrated) that stacks banknotes to be returned or rejected banknotes (hereinafter, “return banknotes”), which have been transported from the escrow unit, and that dispenses the stacked banknotes to the inlet/outlet 5, and the like. Further detailed explanations of the first unit M1 are omitted because they are less relevant to the present invention.

The second unit M2 constitutes the paper sheet discharge stacking device of the present invention, and includes a dispense tray (a discharge tray) 700 provided at the dispense port (the discharge port) 7, a discharge transport stacking unit 500 that transports and discharges dispense banknotes (dispense paper sheets) that have been dispensed one by one from each of the storage units 30 and 40 to the dispense tray 700 and stacks the banknotes thereon, and the like.

A void E for unit attachment is provided between the first unit M1 and the banknote storage unit N, and a banknote discharge device that does not have a change collective dispensing function and the second unit M2 having the collective dispensing function can be replaceably attached in the void E.

That is, a conventional banknote discharge device having a different configuration from that of the second unit M2 can be attached in the attachment void E. This conventional banknote discharge device is configured in such a manner that the following second and subsequent banknotes are not discharged until a user takes out a banknote dispensed one by one from the banknote storage unit N and discharged onto the dispense tray.

In contrast thereto, in the second unit M2 of the present invention, that is, the banknote discharge stacking device, collective taking out of banknotes by a user is enabled after banknotes are successively discharged onto the dispense tray one by one from the banknote storage unit N and stacking of a required number of banknotes is completed.

The banknote storage unit N includes first and second circulation-type banknote storage units (circulation-type banknote storage devices, circulation units) 30 and 40 that store banknotes fed one by one from the escrow unit when receiving of deposited banknotes is confirmed and transported on a storage banknote transport route 9b according to denominations to enable the banknotes to be deposited and dispensed, and the collection container (a collection banknote storage unit) 50 that is attached in a storage space provided below the second circulation-type banknote storage unit 40 to be removable from the front side, and collects all denominations from the circulation-type banknote storage units at the closing time or the like or collects large denomination banknotes that are not used as change and surplus banknotes that cannot be stored in the circulation-type banknote storage units.

The transport mechanism includes a motor, a solenoid, and a pulley for generating or transmitting drive force for transporting banknotes along the transport routes 9a and 9b and other transport routes, a belt, a gate, and the like.

The control unit 1000 controls control targets such as the deposit/dispense processing unit M, the banknote storage unit N, and the transport mechanism.

Each of the first and second circulation-type banknote storage units 30 and 40 in the present example includes two (31 and 35, 41 and 45) circulation drums in each of which the maximum number of stored banknotes is 30. Each of the circulation drums 31, 35, 41, and 45 is a type appropriate for circulation, which stores banknotes between two long tapes (long films) helically (spirally) wound on the outer circumferential surface in a superimposed manner.

### <Various Operations of Banknote Processing Device>

The outline of a depositing operation, a confirming operation, a dispensing operation, and a collecting operation of the banknote processing device 1 illustrated in FIG. 1 is explained next.

First, in the depositing operation, when one or a plurality of banknotes are input from the inlet/outlet 5, the control unit 1000 that receives a signal from a sensor having detected the banknotes actuates the transport mechanism to take the banknotes therein using the collective deposit unit 11 and the deposited banknote transport route 9a. The collective deposit unit 11 takes out banknotes one by one from the topmost banknote in the batch of banknotes set on the inlet/outlet 5 and transports the banknote to the recognition unit 15. Banknotes judged to be acceptable by the recognition unit 15 are transported to the escrow unit (not illustrated) and are wound one by one on the outer circumference of an escrow drum to be escrowed, and wait confirmation of deposit. Return processing for banknotes escrowed in the escrow unit is not directly related to the present invention and explanations thereof are omitted.

At the stage when deposit of the deposited banknotes escrowed in the escrow unit is confirmed, the banknotes are fed one by one from the escrow unit and banknotes to be used as change are stored in either of the circulation-type banknote storage units 30 and 40 according to the denominations through the storage banknote transport route 9b while banknotes that are not used as change are stored in the collection container 50.

At a time when a banknote is dispensed as change, a banknote stored in the circulation-type banknote storage units 30 and 40 that store banknotes according to the denominations is taken out, and the denomination, authenticity, and the like thereof are recognized by a recognition unit 70 provided on the storage banknote transport route 9b. When being a returnable banknote, the banknote is dispensed as change to the dispense port 7.

On the other hand, when a banknote is judged as an unreturnable banknote by the recognition in the recognition unit 70, the banknote is escrowed in the escrow unit and is subsequently transferred to the collection container 50 to be stored therein.

At the time of collection, banknotes stored in the circulation-type banknote storage units 30 and 40 at the closing time and the like are once stacked in the escrow unit and are then stored in the collection container 50.

### <Circulation-Type Banknote (Paper Sheet) Storage Unit>

Each of the circulation-type banknote storage units (circulation-type banknote storage devices=banknote storage units) 30 and 40 generally includes two circulation units (circulation drum units) 100 and 200, and a distribution unit (a flapper) 310 that switches a banknote transport route (an introduction route, a dispensing route) to the side of either of the circulation units in a casing 60.

The circulation units 100 and 200 are means that are actuated under the driving force from a motor (not illustrated) to receive banknotes transported into the casing 60 and to feed stored banknotes to the outside of the casing.

Each of the circulation-type banknote storage units 30 and 40 includes the motor (not illustrated), the first circulation unit (a first circulation drum unit) 100 and the second circulation unit (a second circulation drum unit) 200 that are each actuated under the driving force from the motor to receive and store transported banknotes and feed stored banknotes, the distribution means (flapper) 310 that distributes transported banknotes to either of the circulation units by changing the attitude (position), and a distribution-means driving mechanism (a flapper driving mechanism) that drives the distribution means (flapper) 310.

Configurations of the circulation-type banknote storage units (circulation-type banknote storage devices) 30 and 40 are explained below.

The circulation units 30 and 40 include the circulation drums 31, 35, and 41, 45 that stack banknotes on the outer circumferential surface to be superimposed one on top of another and store the stacked banknotes therein by forwardly rotating, and that discharge banknotes on the outer circumferential surface one by one by reversely rotating, respectively. For example, 1000-yen banknotes are stored in the circulation unit 30, and 5000-yen banknotes are stored in the circulation unit 40.

A first distribution unit 61 that distributes deposited banknotes, which have been transported to the banknote storage unit N, to the circulation-type banknote storage unit 30 or 40 (the collection container 50) is arranged on the storage banknote transport route 9b. A distribution piece 61a for distributing deposited banknotes transported from the deposited banknote transport route 9a to the circulation-type banknote storage unit 30 (an in-casing transport route 9c) or to the circulation-type banknote storage unit 40 (the collection container 50) is arranged on the first distribution unit 61. A second distribution unit 65 and a distribution piece 65a that distribute deposited banknotes to the circulation-type banknote storage unit 40 or the collection container 50 are arranged downstream from the first distribution unit 61.

Since the circulation-type banknote storage units 30 and 40 have substantially the same configurations, the circulation-type banknote storage unit 30 is mainly explained below.

The circulation unit 100 on the front side includes the flapper 310 that distributes banknotes transported sequentially through the distribution piece 61a and the in-casing transport route 9c to either of the circulation drums 31 and 35, the front-side circulation drum (a first circulation drum) 31 to which one ends of tapes (films) T1 and T2 on the front side are fixed and that reels in the both tapes T1 and T2 in a superimposed manner on the circumferential surface when rotating in the clockwise direction, a forwardly and reversely rotatable first bobbin 105 that holds the first tape T1 wound in a helical manner (in a multilayered manner) to be supplied to the outer circumferential surface of the first circulation drum 31, a plurality of guide rollers 106a that guide the first tape T1 reeled out from the first bobbin to the outer circumferential surface of the first circulation drum, a forwardly and reversely rotatable second bobbin 110 that holds the second tape T2 wound in a helical manner to be supplied to the outer circumferential surface of the first circulation drum 31, and guide rollers 111a that guide the second tape T2 reeled out from the second bobbin to the outer circumferential surface of the first circulation drum. The tape T1, T2 is wound on the outer circumferential surface of the first circulation drum though a route along the guide rollers 106a and the guide rollers 111a, or is reeled out from the first circulation drum to the bobbin 105, 110, respectively. The forward rotation and the reverse rotation of each of the bobbins 105 and 110 are performed by a motor (not illustrated).

Banknotes transported from the first distribution unit 61 toward the first circulation drum 31 are introduced into a contact traveling area TA where the both tapes T1 and T2 travel in a superimposed manner, and are stacked on the outer circumferential surface of the first circulation drum that rotates in the reel-in direction (the clockwise direction) while being nipped between the both tapes in a nip part n with the guide roller 106a and the guide roller 111a located at the last position.

When banknotes stacked between the tapes on the outer circumference of the first circulation drum 31 are to be discharged one by one to the outside of the circulation unit 100, the bobbins 105 and 110 are rotated in the reel-in direction while rotating the first circulation drum 31 in the reel-out direction (the counterclockwise direction), so that the tapes T1 and T2 are reversely fed on the same routes as those at the time of reeling out from the bobbins 105 and 110 and are reeled in the bobbins, respectively. The banknotes nipped between the tapes are dispensed from the nip part n sequentially to the first distribution part 61, the in-casing transport route 9c, and the storage banknote transport route 9b.

The last guide roller 106a for the first tape T1 and the last guide roller 111a for the second tape T2 form the nip part n and the tapes T1 and T2 after this nip part are wound on the outer circumferential surface of the first circulation drum 31 in a superimposed manner.

Since the circulation unit 200 on the back side has the same configuration as that of the circulation unit 100 on the front side, like parts are denoted by the same reference signs to omit detailed explanations thereof.

The directions of curling habits formed on banknotes stacked on the outer circumferential surfaces of the circulation drums 31 and 35 that constitute the circulation unit 100 and the circulation drum 41 and 45 that constitute the circulation unit 200 are opposite to each other. That is, the circulation drums 31 and 35 reel in banknotes when rotating in the clockwise direction and rotate in the counterclockwise direction at the time of dispense. Accordingly, a banknote discharged through the storage banknote transport route 9b to the dispense tray 700 has a curling habit with a central part in the long edge direction bulging upward (the both end parts in the long edge direction inclined downward), that is, an upward curling habit formed thereon. Meanwhile, banknotes stacked on the outer circumferences of the circulation drums 41 and 45 have a curling habit with a central part in the long edge direction bulging downward.

### Banknote Discharge Stacking Device: First Embodiment

### <<Basic Configuration>>

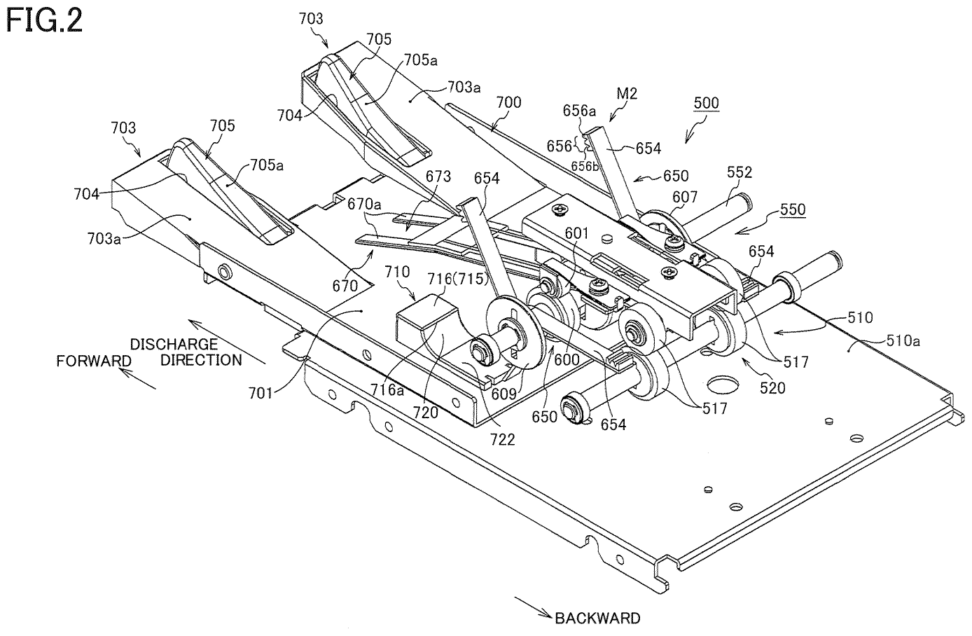

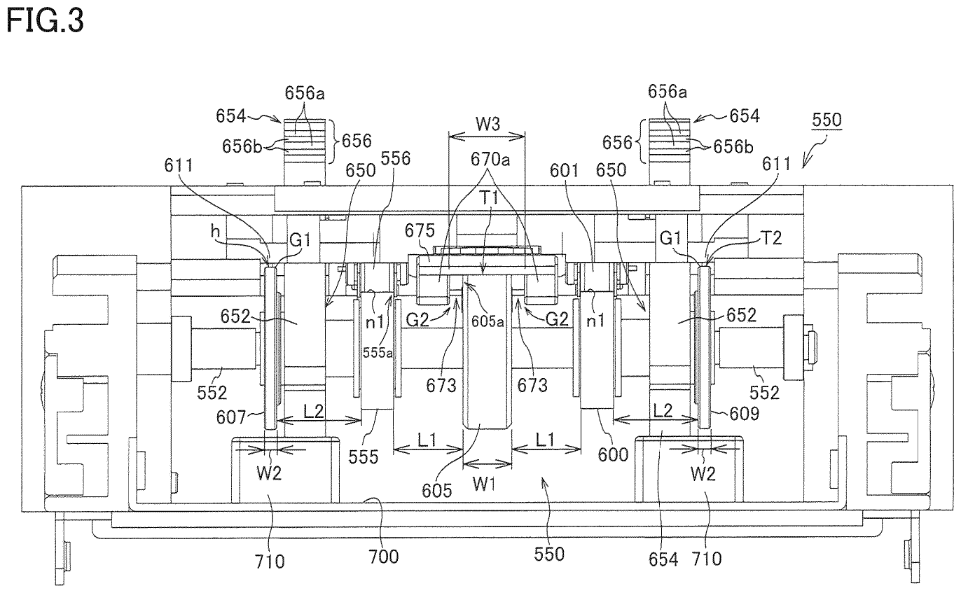

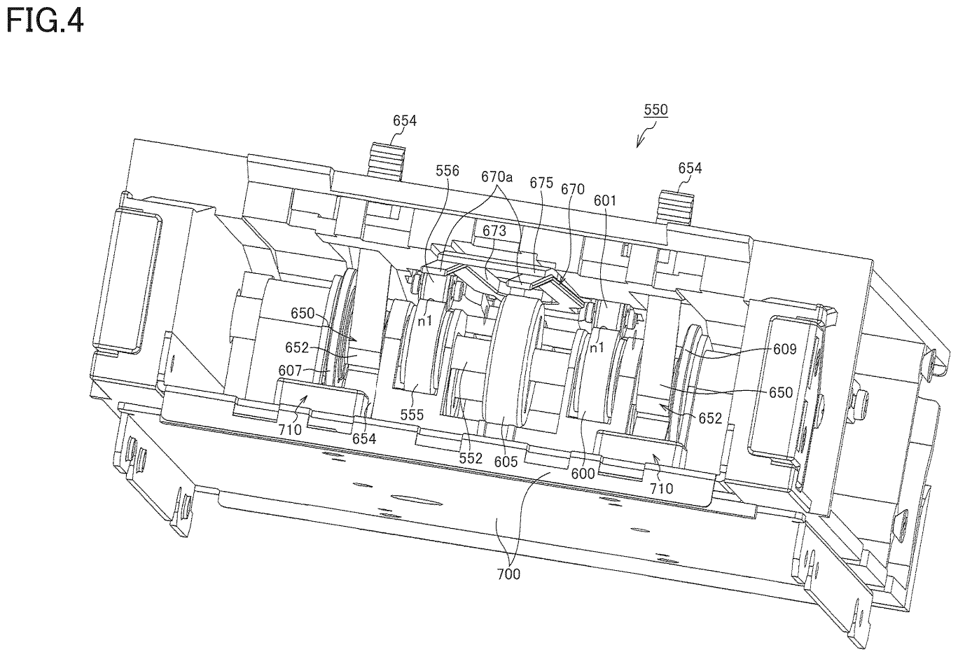

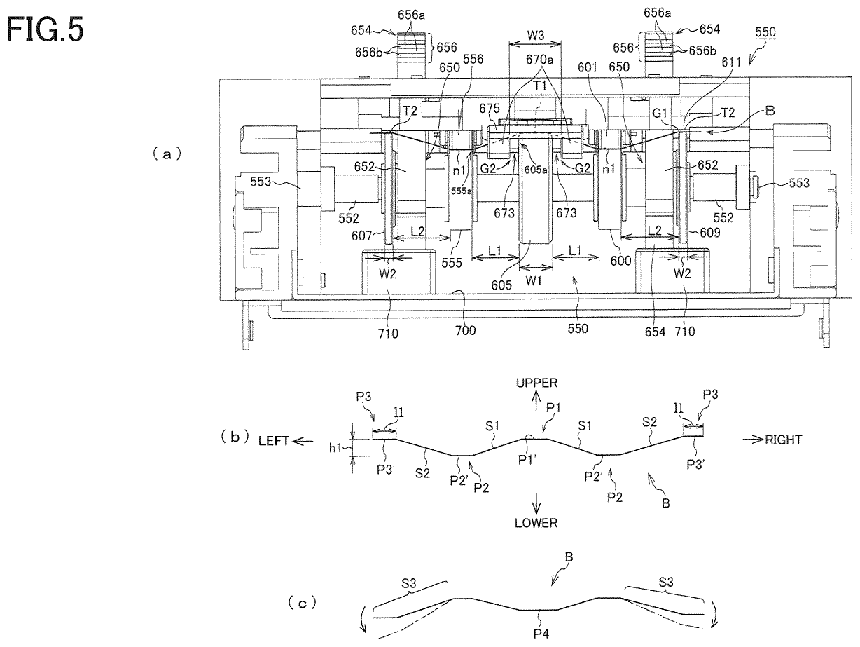

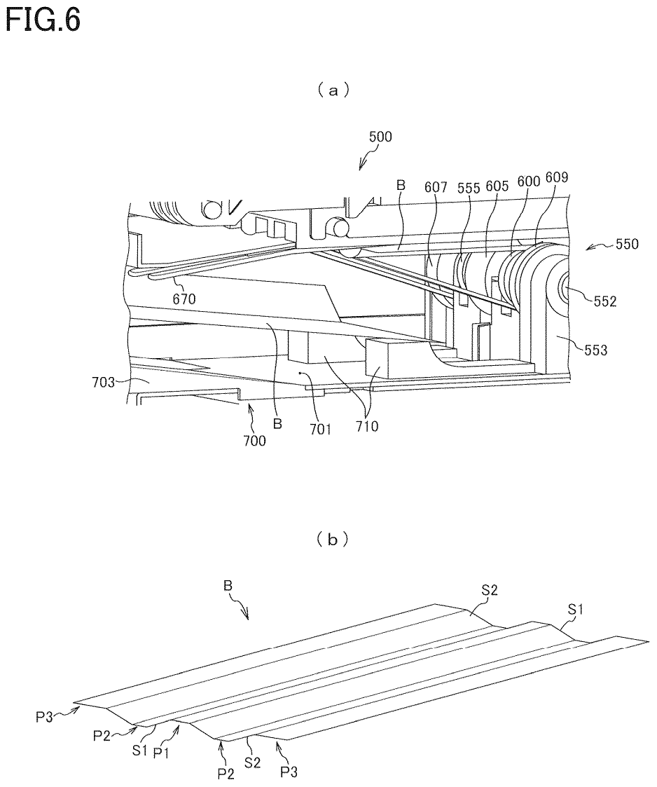

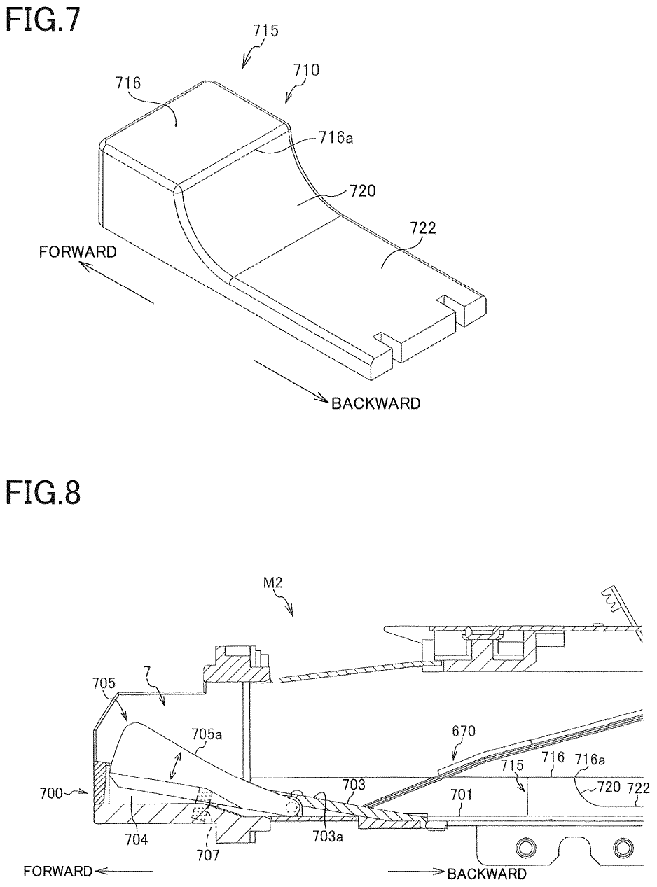

FIG. 2 is a perspective view illustrating a configuration of relevant parts of the second unit M2 according to the first embodiment, FIG. 3 is a front view of a forming mechanism seen from the discharge side, FIG. 4 is a perspective view of the forming mechanism seen from the discharge side, FIGS. 5(a) and 5(b) are a front view illustrating a state where a banknote is formed by the forming mechanism in a shape having a predetermined stiffness and an explanatory diagram illustrating a short side shape of a dispense banknote after being formed, and FIG. 5(c) is an explanatory diagram in a case where the short side of a banknote is formed into an M shape. FIG. 6(a) is a front-side perspective view illustrating a positional relation between a banknote immediately after being discharged from the forming mechanism and an already-stacked banknote, and guide members, and FIG. 6(b) is a perspective view illustrating a shape of a formed banknote. FIG. 7 is a perspective view illustrating a configuration of the guide member, and FIG. 8 is a vertical sectional view illustrating a configuration of the dispense tray.

The second unit (the banknote discharge stacking device, the collective dispensing unit) M2 includes the dispense port 7, the discharge transport stacking unit 500 that transports dispense banknotes (dispense paper sheets) B output from the storage units 30 and 40 to the dispense port 7, the dispense tray (discharge tray) 700 that is provided on the dispense port 7 and that stacks (layers) banknotes discharged from the discharge transport staking unit, and the like.

The second unit M2 is means for discharging banknotes dispensed one by one from the circulation units 30 and 40 that receive and store transported banknotes and that dispense stored banknotes to outside, onto the dispense tray 700 and for stacking the banknotes.

The second unit M2 successively discharges a plurality of dispensed banknotes for change one by one with a short side at the head and stacks the banknotes on the dispense tray 700, and enables a user to take out a batch of stacked banknotes collectively at the time of completion of the stacking. Taking out of the banknotes from the dispense tray is enabled after all the banknotes are discharged.

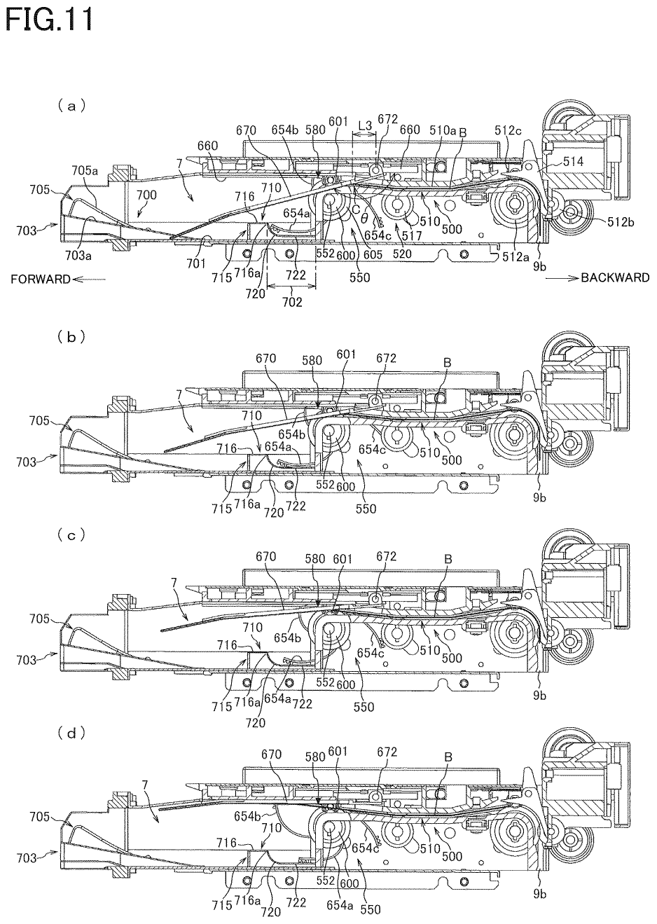

As illustrated in FIGS. 1, 11, and the like, the discharge transport stacking unit for that constitutes the second unit M2 includes a discharge transport route 510 on which a banknote is discharged and transported toward the dispense tray, a discharge transport mechanism 520 that provides a banknote on the discharge transport route 510 with a transport force, a forming mechanism (a rigidity providing unit) 550 that forms (deforms) the short side shape (the shape in the short edge direction) of a dispense banknote B (hereinafter, “banknote B”) to be discharged onto the dispense tray 700 into a predetermined shape across the entire length in the long edge direction, thereby providing the banknote B with a stiffness (a rigidity and a shape retaining force) across the entire length thereof, and a tracking sensor 580 that detects entry of the leading end part of the banknote B into the forming mechanism and discharge of the rear end part thereof. A banknote B having entered the discharge transport route 510 is transported to the forming mechanism 550 by transport members such as a transport roller 517 and the like that constitute the discharge transport mechanism 520.

Since the discharge transport route 510 includes upper and lower transport guides 510a that sandwich a banknote B from upper and lower directions, and a transport roller pair 517 that transports the banknote B while nipping the banknote B, and the like, even a banknote having a curling habit or a limp banknote can be transported while being adjusted (pressurized and deformed) to a straight and flat attitude. Accordingly, a banknote transported within the discharge transport route is in a state of having the stiffness of a predetermined level or higher. However, the adjustment of the attitude in the discharge transport route is temporary and the curling habit is not completely corrected. That is, when a banknote having a curling habit is discharged as it is onto the dispense tray without passing through the forming mechanism, the curling habit returns on the dispense tray.

The discharge transport mechanism 520 includes rollers 512a, 512b, and 512c for transporting a banknote (dispense banknote) B output from the storage unit 30 or 40 and moved upward along the storage banknote transport route 9b to the forming mechanism 550, a flapper 514 that switches the attitude of a banknote (deposited banknote) transported from the first unit M1 between an attitude for guiding to the banknote storage unit N and an attitude for guiding the transport direction of the banknote to the second unit M2 (the forming mechanism 550), a flapper driving unit (such as a solenoid, not illustrated), the discharge transport route 510 to the forming mechanism, the transport roller pair 517 arranged on the discharge transport route, a motor or a solenoid as a driving source for each driving target, and the like.

The rollers 512a and 512b forwardly rotate when a deposited banknote introduced from the first unit M1 is to be transported to the corresponding storage unit 30 or 40, and reversely rotate when the banknote B is to be sent to the forming mechanism 550. The flapper 514 in the illustrated state is in the attitude for transporting the banknote B having been moved upward on the storage banknote transport route 9b to the forming mechanism 550. By pivoting in the clockwise direction by a required angle, the flapper 514 transitions to an attitude where the storage banknote transport routes 9b and 9a are communicated with each other.

### <Forming Mechanism>

The forming mechanism 550 is means for forming the short side shape of various banknotes curled, creased, wrinkled, or the like, or a partially or entirely limp banknote (a banknote having a deteriorated property) across the entire length in the long edge direction into a predetermined shape to increase the stiffness in the long edge direction or correct the shape to be appropriate for stacking. The correction effect (forming effect, shape retaining effect after forming) provided by the forming mechanism is not temporary and the corrected shape is continuously maintained also after the banknote is discharged onto the dispense tray.

In the embodiment described below, an example in which a banknote having an upward curling habit in the long edge direction due to the circulation drum is formed by the forming mechanism to provide a stiffness (to correct the curling habit) is explained. However, the forming mechanism can generally address banknotes having a deteriorated property that may cause a landing failure, a stacking failure, or the like, when these banknotes are discharged onto the dispense tray without passing through the forming process, such as banknotes having various habits other than a curling habit or deformations, limp banknotes, and the like.

A specific configuration example of the forming mechanism 550 is explained with reference to FIGS. 2 to 5.

The short side shape of a banknote indicates the shape (front shape) of an end edge of a short side of the banknote when seen from the front as illustrated in FIGS. 5(a) and 5(b).

The forming mechanism 550 generally includes a rotation shaft 552 that is rotatably supported in a horizontal attitude at the both end parts by bearing parts 553, a discoid (roller-like) central flange 605 having an axis fixed by an appropriate place of the rotation shaft, in this example, a portion of the rotation shaft corresponding to a central part in the width direction of the discharge transport route 510, two drive rollers 555 and 600 that respectively have axes fixed by the rotation shaft at positions separated by predetermined distances L1 on the both sides in the axial direction of the central flange 605, and discoid outer flanges 607 and 609 that respectively have axes fixed by the rotation shaft at positions separated by predetermined distances L2 on outer sides in the axial direction of the drive rollers 555 and 600.

In other words, the wide central flange 605 is arranged coaxially at an intermediate position between the drive rollers 555 and 600, and each of the narrow outer flanges 607 and 609 is arranged on the outer side in the axial direction of the associated drive roller with the predetermined distance L2 away from each other. A width W1 (6 mm) of a contact face (an outer circumferential surface) of the central flange 605 with a banknote is set wider than a width W2 (2 mm) of a contact face of each of the outer flanges 607 and 609 with the banknote. The reason why the width W1 of the central flange is set wider is as follows. If the width of the central flange is too small, gaps G2 between the central flange and an opening part 673 of a lever 670 become too large and a part of a banknote sinks in the gaps, so that the discharged banknote becomes saggy, and the stiffness to push up the lever is decreased, as will be described later. The ratio between the width W1 of the central flange and the width W2 of the outer flanges is, for example, about 4:1.

The outside diameters of the central flange 605, and the outer flanges 607 and 609 are configured to be larger than the outside diameters of the drive rollers 555 and 600. Each of the flanges is a discoid member that is constituted of a resin, a metallic material, or the like having a sufficient hardness so as not to deform when being brought into contact with a banknote.

Each of tension rollers 556 and 601 as driven rollers is arranged at a position immediately above the associated drive roller 555 or 600 in a one-to-one relation with the drive roller and forms a nip part n1 with the outer circumferential surface of the corresponding drive roller. The outer circumferential surfaces of the drive rollers 555 and 600, and the tension rollers 556 and 601 are constituted of a material having a sufficient frictional resistance so as not to cause slipping between the outer circumferential surface and a banknote.

Height positions T1 and T2 of the uppermost portions of the outer circumferential surfaces of the flanges 605, 607, and 609 are located above the nip part n1 with each of the driving rollers and the corresponding tension roller. Accordingly, during passing of a banknote B through the rotation shaft 552, the banknote B is pressurized and pressed by the nip parts n1 and the flanges and is deformed, so that protruded parts P1 and P2, an upwardly oblique sides S2, and protruded parts P3 can be formed (see FIGS. 5(a) and 5(b)).

A restriction member 611 may be arranged with a gap G1 away from the uppermost part T2 of each of the outer flanges 607 and 609 to restrict the extending direction of the both end parts of the short side of a banknote. A fixing member, a roller, or the like having a low frictional resistance to a banknote may be used as the restriction member 611.

When a narrow banknote is discharged from the forming mechanism, the both end parts of the short side of the banknote sometimes excessively rise up without hanging down. The rising both end portions of a banknote stacked on the discharge tray in this state become a cause of hit at the time of dispense of the next banknote and cause dropping of the preceding banknote from the discharge tray. To solve this problem, it is effective that the extending direction of the both end parts of the short side is restricted by the restricting member 611.

If the both end parts of the short side of a wide banknote excessively rise up at the time of discharge from the forming mechanism due to forming of the banknote into a W shape, the end parts become higher than the height of the space on the dispense tray and interfere with the ceiling (a frame 660) of the space in some cases. A risk of a banknote jam occurs at that time. The risk of a jam can be reduced by previously restricting excessive rising with the restriction member 611 at the time of forming.

In a banknote having a particularly great stiffness, the both end parts of the short side of the banknote may keep a rising state without hanging down and there is a possibility that the rising end parts block the discharge route after the banknote is stacked on the dispense tray. Therefore, it is effective that the extending direction of the both end parts of the short side is previously restricted by the restriction member.

In the example illustrated in FIGS. 5(a) and 5(b), to cause the short side shape of a banknote B to become a substantially bilaterally symmetrical shape, the forming mechanism 550 forms the upward protruded part (a bent part protruded upward) P1, the downward protruded part (a bent part protruded downward) P2, and the upward protruded part P3 alternately along the short side direction of the banknote, and inclines the both end sides S2 and S2 of the short side of the banknote upward (to be protruded obliquely upward).

The upward protruded part P1 includes a top part P1′, and oblique sides S1 and S1 respectively extending from the top part P1′ to the right and left (outward) to be inclined downward. Each of the downward protruded parts P2 includes a top part (a bottom part) P2′, and the oblique sides (end sides) S2 and S2 respectively extending from the top part P2′ to the right and left to be inclined upward. The upward protruded parts P3 and P3 are formed at terminal end parts of the oblique sides S2 and S2, respectively.

The top part P1′ of the central protruded part P1 is formed at a position corresponding to the outer circumferential surface of the central flange 605, the top parts P2′ of the right and left protruded parts P2 are formed at positions corresponding to the nip parts n1 with the drive rollers 555 and 600 and the associated tension rollers 556 and 601 (the last roller pairs), and the top parts P3′ of the outer protruded parts P3 are formed at positions corresponding to the outer circumferential surfaces of the outer flanges 607 and 609.

That is, the central protruded part P1 is formed by pressing a central part of a banknote upward with the central flange 605 in a state where the right and left positions are held by the right and left nip parts n1. The downward protruded parts P2 are formed by pressing the banknote downward by the nip part n1 with the drive roller 555 and the tension roller 556 and the nip part n1 with the drive roller 600 and the tension roller 601. The outer oblique sides S2 and the protruded parts P3 are formed by the outer flanges 607 and 609 and the restriction member 611 in a state of being held by the nip parts n1.

That is, at the time of passing of a banknote B, one upward protruded part P1 is formed at a central part (a central part in the width direction) of the short side of the banknote B, one downward protruded part P2 is formed on each of the right and left sides of the protruded part P1, and the upward protruded parts P3 and P3 are further formed on the right and left sides of the downward protruded parts P2 and P2, respectively. Accordingly, the both end sides of the banknote can be corrected (provided with a habit) to a state of being raised upward (inclined upward) to form the oblique sides S2 and S2. The short side shape of the banknote after the forming is a substantially bilaterally symmetrical shape. The protruded parts (P1, P2, and P3) and the oblique sides S1 and S2 being the formed places are continuously formed across the entire length in the long edge direction of the banknote. Accordingly, a curling habit (a curved shape) having been formed along the long edge direction of a banknote discharged onto the dispense tray is corrected, the shape of the banknote in the long edge direction becomes a shape close to a substantially flat or substantially straight shape, and the shape is maintained (retained). That is, the short side of a banknote B is bent (curved) at plural places to alternately form the upward protruded part P1, the downward protruded part P2, and the upward protruded part P3, whereby the curling habit of the banknote having a curved shape seen from the long edge direction can be eliminated and the shape seen in the long edge direction can be brought to be a substantially straight shape (non-curled shape). In other words, with alternate provision of the upward and downward protruded parts along the short side, the stiffness (the rigidity) along the entire length in the long edge direction of a banknote can be increased and a force (a shape retaining force) to retain a substantially flat or substantially straight shape can be provided.

Accordingly, the attitude of a banknote in the long edge direction emitted from the forming mechanism 550 can be upturned and hit against a rear part of an already-stacked banknote can be prevented by the upturned attitude. Particularly when the rear end part of an already-stacked banknote rises up due to a habit, the rear end part is likely to hit the leading end part of the following banknote. However, the hit prevention effect for such already-stacked banknote is enhanced with the following banknote that has a stiffness increased to have a flat and upturned attitude.

Banknote portions corresponding to the downward protruded parts P2 are discharged from the forming mechanism in a state of being gripped by the nip parts n1 of the last roller pairs and accordingly do not hang down during the discharge. Furthermore, since the protruded parts P1 and P2 are in a state of being formed in a mountain shape (a valley shape) and retaining the shape also after the discharge from the forming mechanism, and a high tension is applied to the oblique sides S1 each connecting the protruded parts P1 and P2, the protruded parts do not hang down.

Each of the oblique sides S1 is formed while the banknote is stretched in a state where a sufficient tension is applied between the outer circumferential surface of the central flange 605 and the nip part n1 of the associated last roller pair. Each of the oblique sides S2 is formed while the banknote is stretched in a state where a sufficient tension is applied between the associated nip part n1 and the outer circumferential surface of the outer flange 607 or 609. Accordingly, the oblique sides S1 and S2 do not sag or hang down during discharge from the forming mechanism and after the discharge. Even in a case where the short side of a banknote is long, since the protruded parts P2 are in a gripped state during discharge and are originally inclined upward, the oblique sides S2 do not hang down to such an extent that interference with the already-stacked banknotes occurs. That is, since the protruded parts P1 and P2 are in a state of being retained in a mountain shape (a valley shape) and a high tension is applied to the oblique sides S1 each connecting between protruded parts and the oblique sides S2 on the outer side also after completion of discharge from the forming mechanism, the oblique sides S2 do not greatly hang down. Even if the oblique sides hang down after completion of the discharge, the hanging amount is not so large.

Accordingly, the entire height h1 after forming can be reduced and the dimensions of components constituting the forming mechanism in the upper-lower direction can be reduced.

The top part P1′, P2′, or P3′ of each of the protruded parts P1, P2, and P3 is not formed in a shape tapered at an acute angle or an obtuse angle and has a shape to which the shape of the outer circumferential surface of the central flange 605, the drive roller 555, 600, or the outer flange 607, 609 is transferred, that is, is substantially flat. In sum, when the curved shape of a banknote in the long edge direction can be corrected to a shape close to a flat or straight shape by forming the protruded parts continuously across the entire length in the long edge direction of the banknote, the object to increase the stiffness (provide the shape retaining force) by forming can be achieved regardless of the shapes of the top parts of the protruded parts P1, P2, and P3.

As long as the end sides S2 located on the outermost sides are configured to be inclined upward, the number of each of the protruded parts P1, P2, and P3 can be any number. That is, the formed banknote may have a shape other than a W shape.

While the height position of the protruded part P1 at the center of a banknote B after forming and the height positions of the outer protruded parts P3 and P3 are substantially the same in the present embodiment, the height positions of the protruded parts P3 and P3 may be higher or lower than that of the protruded part P1.

In a case where the height positions of the top parts P3′ of the protruded parts P3 are higher than the height position of the top part P1′ of the protruded part P1, the outside diameters of the outer flanges 607 and 609 are configured to be larger than that of the central flange 605. In this case, the uppermost parts T2 of the outer circumferential surfaces of the outer flanges are located at a higher position than the uppermost part T1 of the central flange. Therefore, the possibility that the oblique sides S2 and the top parts P3′ of a discharged banknote are caught on the rear part of an already-stacked banknote can be further reduced.

While the height positions of the downward protruded parts P2 and P2 are substantially the same, these height positions may be different from each other.

While the short side shape after forming is a bilaterally symmetrical shape in the illustrated embodiment, this is merely an example and the shape does not need to be bilaterally symmetrical as long as it can provide a sufficient stiffness.

When the oblique sides S1 and S2 located between the protruded parts of a formed banknote have a normal level of stiffness (particularly, a stiffness in the short side direction) of a banknote, the oblique sides S1 and S2 are in a state of extending in a substantially linear manner with a sufficient tension as illustrated in FIG. 5(b).

Another advantage of forming of a banknote into a W shape, that is, a shape in which the oblique sides S2 and S2 on the both ends are inclined upward is that a sufficient stiffness can be provided while the entire height h1 after forming is a required minimum. Since the entire height h1 could be reduced to about 2.5 mm in experimentations, the diameter of each of the rollers and the flanges constituting the forming mechanism can be downsized and the bulk of formed banknotes does not become considerably large.

However, when the stiffness of a banknote is significantly decreased as described later, the oblique sides S1 and S2 between the protruded parts have a lower tension and are likely to be in a sagged state. Therefore, the shape retaining property during discharge from the forming mechanism or after the discharge is decreased. Measures against this problem will be described in a third embodiment.

If the short side of a banknote B is formed into an M shape as illustrated in FIG. 5(c), both end sides S3 of the short side are inclined downward and are likely to hang down. Accordingly, when the banknote B is discharged onto the dispense tray, the both end sides S3 are caught on a banknote previously stacked on the dispense tray (particularly, a banknote with a rear end part having a habit of protruding upward) and cause dropping of this banknote. If a banknote is formed into an M shape, the outer end sides S3 are likely to greatly hang down beyond the height position of a downward protruded part P4 and this causes enlargement of catch on an already-stacked banknote. Particularly, in a case where the short side of a banknote is long, the outer end sides S3 are longer than the illustrated one and the hanging state becomes worse.

Therefore, a formed shape in which the both end parts of the short side are inclined downward or hang down cannot be adopted.

Banknotes issued in countries in the world are broadly divided into narrow banknotes where the maximum size (the maximum width dimension) of the short side is less than 72 millimeters (mm), such as those in the USA, Canada, and Australia, and wide banknotes where the maximum width dimension is equal to or more than 72 mm and less than 86 mm, such as those in Japan, the Eurozone, and Macau.

When a manufacturer of banknote processing devices manufactures banknote processing devices for countries in which the narrow banknotes circulate and other countries in which the wide banknotes circulate, it is disadvantageous to manufacture devices having different specifications according to the countries. That is, it is apparently disadvantageous in terms of an increase in the manufacturing cost, inventory control cost, and the like, to prepare two types of banknote processing devices that have no structural difference other than the difference in the width of the transport path and to manufacture and ship one of the types according to an order.

To address the disadvantage and inconvenience described above, measures to prepare only one type of device including a wide transport path that enables a wide banknote to be transported, and to use the device in common for narrow banknotes are adopted.

Particularly, in a case where the second unit M2 is incorporated into the banknote processing device 1, the forming mechanism 550 is required to have a configuration to form a shape that can provide a sufficient stiffness to banknotes in common regardless of the size of the short side of the banknotes.

However, in a circulation unit including a circulation drum, since banknotes are stored in a state of being wound on the outer circumferential surface of the circulation drum, a habit (a curling habit) curved in the long edge direction is formed on the banknotes. Particularly when an upward curling habit bulging upward is formed on a central part in the long edge direction of each of banknotes transported from the circulation unit and discharged onto the dispense tray 700, a problem that the leading end part (inclined downward) of a newly-discharged banknote hits the rear part of an already-stacked banknote and pushes the already-stacked banknote to drop out of the dispense tray occurs. Even when there is no already-stacked banknote, a newly-discharged banknote having an upward curling habit slips on the dispense tray to drop beyond the distal end edge thereof or buckles between the banknote holding lever and the upper surface of the dispense tray due to the downward curve of the leading end.

In the present invention, the conventional problem is solved by forming the shape of a banknote in the short edge direction across the entire length into a predetermined shape (a shape having a stiffness) using the forming mechanism 550.

In the forming mechanism 550 of the present embodiment, the distance L1 from each of the drive rollers 555 and 600 to the central flange 605, and the distance L2 from the flange 607 or 609 to the drive roller 555 or 600 are set as L1=8 mm to 9 mm and L2=10 mm to 11 mm to enable handling of narrow banknotes having the maximum width dimension of 72 mm or less. That is, in a case where the short side shape is formed into a W shape as in the present embodiment, the positional relation between each of the drive rollers and the associated flange is set to cause the both end sides S2 in the short edge direction of a narrow banknote to be inclined upward.

With this setting of the positional relation of the drive rollers 555 and 600 centered on the central flange 605, and the positional relation of the flanges 607 and 609 centered on the central flange to be adapted to narrow banknotes, a similar habit in the short edge direction to that of narrow banknotes can be provided also to wide banknotes having the maximum width dimension equal to or more than 72 mm and less than 86 mm.

While the positions of the protruded parts P1, P2, and P3 in the short edge direction are fixed irrelevant of the sizes of the short sides of banknotes, a length 11 of the top part P3′ of each of the outermost protruded parts P3 varies according to the sizes of the short side of banknotes B.

However, by settling at least the axial positions of the flanges 607 and 609 on the both sides, that is, the interval between the flanges 607 and 609 to enable less than 72 mm being the minimum banknote width to be addressed, appropriate forming of wide banknotes can be performed while the layout of the drive rollers and the flanges is fixed.

That is, since narrow banknotes and wide banknotes are both transported in such a manner that the central part of the short side thereof substantially matches the central part of the central flange 605 in the width direction on the discharge transport route 510, the places where the upward protruded parts P1 and P3 and the downward protruded parts P2 are formed (the distances from the central part of the short side) are the same and only the length 11 of a portion extending outward from each of the protruded parts P3 is different.

The length 11 of the top part P3′ of each of the outermost protruded parts P3 is short in a banknote where the length of the short side is less than 72 mm, while the length 11 of the top parts P3′ is longer when the short side is longer than 85 mm. However, since the top parts P3′ are gripped by the outside flanges 607 and 609 during discharge from the forming mechanism, the top parts P3′ are prevented from greatly hanging down. In a banknote having a normal stiffness also after discharge, hanging down thereof is similarly prevented.

Meanwhile, since the device is configured in the layout in which all the drive rollers and the flanges are positioned within 72 mm, which is the short side dimension of narrow banknotes, the both end sides of wide banknotes have a shape greatly protruded downward if the short side is deformed into an M shape. Accordingly, an already-stacked banknote on the dispense tray is likely to hit the leading end of the following banknote newly discharged. As a result, a stacking failure such as pushing an already-stacked banknote to be dropped out of the dispense tray, or buckling deformation of the following banknotes occurs.

### <Stacking Wheel>

The discharge transport stacking unit 500 further includes stacking wheels 650. That is, each of the stacking wheels 650 has an axis fixed by the rotation shaft 552 at a position outer in the axial direction than the drive roller 555 or 600 and inner than the flange 607 or 609. Each of the stacking wheels 650 has a configuration in which blades 654 having the same length are fixed on the outer circumference of a small-diameter base part 652 at predetermined intervals in the circumferential direction to be protruded radially. In this example, three blades 654 are arranged at intervals of 120 degrees. Each of the blades 654 is narrow band-like, is constituted of a material easily elastically deformed such as a rubber plate, and has a shape curved toward the rotation direction at least as a whole. Alternatively, each of the blades 654 may be configured to be curved by a centrifugal force at the time of rotation of the stacking wheel.

Since the stacking wheels 650 are arranged on the same axis as that of the drive rollers 555 and 600, the blades 654 have a risk of interfering with a banknote discharged from the nip parts between the drive roller and the tension roller (the last roller pairs) and hindering the discharge depending on settings of the circumferential intervals of the blades or the rotation speed of the stacking wheels. To eliminate such a risk, the discharge speed of banknotes and the rotation speed of the blades are set to enable discharge of an individual banknote to be started and the discharge to be completed in the circumferential interval of 120 degrees between one blade and the next blade.

While a banknote is passing the last roller pairs, any blade does not interfere with the banknote. However, as will be described later, after the rear end of the banknote has passed through the last roller pairs, a blade rotating from above interferes with the banknote and is in contact therewith to perform an operation of sweeping the banknote downward and backward.

Each of the blades 654 of the stacking wheel according to the present embodiment is a flat and sheet-like band body made of an elastic material such as rubber and a high friction region 656 where small convex parts 656a and concave parts 656b are alternately arranged is provided on the distal end face (a contact face with a banknote) of the blade. The convex parts 656a constituting the high friction region 656 are constituted of a material having a higher frictional coefficient than that of the material of the blade main body. If the face being in contact with a banknote is flat as a whole, the frictional resistance decreases due to adhesion of paper dust or dirt. However, with presence of the high frictional region 656 constituted of the convex and concave parts, slip between the face and a banknote can be prevented. Particularly, by causing paper dust to penetrate recessed places, decrease in the frictional resistance resulting from paper dust is prevented, and the high friction region itself is elastically deformed by contact with a guide member to perform an expanding and contracting motion, so that the paper dust in the recessed places is easily discharged and an automatic cleaning function can be provided. Furthermore, the provision of the high friction region 656 can increase the durability of the distal end portions of the blades that are likely to be worn due to rubbing with banknotes.

The high friction region 656 of the present embodiment has the convex parts 656a that are cuboids being long and extending in the width direction of each of the blades and the concave parts 656b that are grooves located between two convex parts 656a. However, this is merely an example and any high friction region may be applied as long as it has a configuration where convex parts and concave parts are alternately arranged.

### <Banknote Holding Lever>

The discharge transport stacking unit 500 further includes the banknote holding lever (hereinafter, “lever”) 670 for holding down a banknote emitted vigorously from the forming mechanism while decelerating the banknote to stop (land) the banknote at an appropriate position on the face of the dispense tray 700. The lever 670 is configured to have a rear end part (a rear part) supported about an axis by a lever shaft 672 to be pivotable in the upper-lower direction, thereby enabling a portion ahead of the rear end portion, particularly a portion protruded on the dispense tray to be pivotable in the upper-lower direction. The lever 670 is lowered by its own weight on the upper surface of the dispense tray 700 (or already-stacked banknotes) in normal times when a banknote discharge operation by the forming mechanism 550 is not performed, and is pushed up by a banknote B to allow passing thereof when a banknote having a sufficient stiffness passes the forming mechanism 550.

That is, the lever shaft 672 is provided on a frame 660 positioned above the rotation shaft 552, the rear part of the lever 670 has the axis supported by the lever shaft 672 to be pivotable in the upper-lower direction, the lever is lowered in a circular arc motion due to its own weight on the dispense tray (or the already-stacked banknotes), and is pushed up by a banknote when the banknote is discharged.

The lever shaft 672 is positioned in the rear of the rotation shaft 552 (upstream of the banknote transport direction on the discharge transport route) and above the rotation shaft. A pivot trajectory of the lever 670 in the upper-lower direction on the lever shaft is in an axial position relation interfering with the central flange 605. That is, the width dimension of the lever has a value interfering with the central flange 605. However, an opening part (an interference avoiding part) 673 is formed at a central part of the distal end edge of the lever in the width direction to avoid interference with the flange 605. That is, the distal end edge of the lever 670 is branch ends 670a bifurcated and the opening part 673 which the central flange enters is formed between the branch ends. The branch parts 670a are each made of a narrow band-like plate material and extend in parallel with the opening part 673 interposed therebetween. Due to presence of the opening part 673, the lever can pivot downward beyond the central flange 605 while avoiding the central flange, and can move to the side of the upper surface of the dispense tray 700.

The function of the lever 670 is to continue to be in contact (slidingly contact) with the upper surface of a banknote B in the process of discharge of the banknote transported on the discharge transport route 510 from the forming mechanism 550, thereby applying a downward pressure to the banknote due to the own weight of the lever to stably land the banknote on the dispense tray 700, and to hold down banknotes stacked on the dispense tray to prevent uplift.

Therefore, the lever at the lowered position needs to allow passing of a banknote having a sufficient stiffness and having passed through the forming mechanism by being pushed up by the banknote promptly and at a high responsivity. Meanwhile, since the lever needs to hold down the already-stacked banknotes, a weight member 675 is fixed at an appropriate place of a lever front part to add the weight as required.

That is, if the lever is not sufficiently pushed up by an emitted banknote, a problem that the banknote cannot reach the normal stop position on the dispense tray and stops in a buckled state in the rear on the dispense tray or hits the rear part of an already-stacked banknote to push out the banknote is produced. Accordingly, the lever needs to be reduced in the weight so as to be pushed up by a banknote to a sufficient height. Meanwhile, the lever needs to have such a weight as to pressurize the upper surfaces of already-stacked banknotes to prevent uplift when the lever is lowered.

As will be described later with reference to FIG. 11 and the like, the leading end part of a banknote B transported on the discharge transport route 510 can be brought into contact with the lower surface of the lever and start pushing up the lever at a position between the lever shaft 672 and the rotation shaft 552. In the discharge transport route 510, a banknote is deformed to a flat attitude by compression of the transport guides 510a arranged at upper and lower places with a narrow interval or by a nipping force of the transport roller pair 517, and a large stiffness is temporarily applied to the banknote. Accordingly, even when a banknote having a curling habit or being limp presses the lever upstream from the rotation shaft 552, the banknote can start pushing up the lever without being crushed or buckled. Furthermore, since the leading end part of a banknote having passed through the forming mechanism 550 is formed into a W shape and is provided with a large stiffness, the banknote can advance while promptly pushing up the lever with a greater force and can land and stop at an optimum position on the dispense tray.

It is considered that the reason why the weight is generally added to the lever by the weight 675 is to enable the banknote processing device 1 to address banknotes of different weights, materials, levels of the stiffness, and the like when the banknote processing device 1 is designed to be adapted in common to different banknotes in the countries across the world. That is, the lever has a function to push a banknote discharged from the forming mechanism forward to facilitate discharge (advance) thereof and a function to hold down a banknote being discharged to control the landing position. It has been considered that, in a case where the weight of the lever is fixed even though the conditions such as the weights of banknotes greatly vary, a situation in which the lever is too lightweight or too heavy as compared to a banknote arises and the functions of the lever cannot be appropriately provided, so that weight adjustment using a weight is required. However, in experimentations using the banknote discharge stacking device M2, it has been confirmed that banknotes in countries across the world can be addressed only with attachment of a weight of 10 grams to the lever. That is, in the present embodiment, attachment of a weight of a certain heaviness to the lever suffices and it is unnecessary to adjust the weight according to the condition such as the type of banknotes.

However, it is also confirmed that adjustment of the heaviness of the weight is effective for limp banknotes to normalize the operation of the lever regardless of the type of banknotes.

### <Dispense Tray>

The dispense tray (discharge tray) 700 is means for receiving banknotes discharged (emitted) from the forming mechanism 550 and stacking the banknotes and, as illustrated in the perspective view of FIG. 2, the vertical sectional view of FIG. 8, and the like, generally includes a base surface (a first upper surface) 701 substantially horizontal and flat, inclined protruded parts 703 that are respectively provided from both end parts of the base surface in the width direction near the distal end to be protruded forward and that each have an upward inclined surface (a second upper surface) 703a on the upper surface, retractable members (inclined surface forming members) 705 that are each configured to enable a front part to pivot in the upper-lower direction by having a rear end part supported about an axis in an elongated groove (hole) 704 provided at an inner edge part of each of the inclined protruded parts, and elastic members 707 that each bias the associated retractable member to a protruded position illustrated in FIGS. 2 and 8. Each of the retractable members 705 is biased to the protruded position by the elastic member in normal times, and an upper surface 705a is an inclined surface that is upward inclined relative to the inclined surface 703a of the inclined protruded part 703. Therefore, the retractable members 705 can brake a banknote that is moving forward along the inclined protruded parts 703 to decelerate and stop the banknote, and prevent the banknote from dropping. A frictional sheet for increasing the frictional resistance to a banknote is stuck on the upper surface 705a of each of the retractable members. In a case where the frictional sheet is not provided, there is a risk that an emitted banknote slides on the upper surfaces 705a made of a resin and jumps out of the dispense tray due to momentum of the banknote. However, the upper surfaces 705a as inclined surfaces including the frictional sheet can effectively decelerate the banknote.

For second and subsequent banknotes, a sufficient frictional resistance to an already-stacked banknote can be provided and the deceleration effect can be further achieved.

After discharge and stacking of a predetermined number of banknotes on the dispense tray are completed and when a batch of the stacked banknotes is to be taken out collectively, a user can depress the retractable members 705 with fingers and cause the upper surfaces 705a to be retracted into the grooves 704. Accordingly, the retractable members do not hinder an operation of taking out the banknote batch and the banknote batch can be easily taken out. Further, when a jam such as buckling of a banknote occurs in the back of the dispense tray, fingers can be inserted into the back by depressing the retractable members and the jammed banknote can be taken out.

### <Guide Members (Guide Protruded Parts)>

As illustrated in the drawings, one guide member (guide protruded part) 710 as a projection is arranged at a position on the base surface 701 of the dispense tray 700 and corresponding to (interfering with) the movement trajectory of the blades 654 of each of the stacking wheels 650. As described later, by a cooperative operation with the stacking wheels, the guide members trap a discharged banknote B before the banknote advances as it is to complete landing on the dispense tray, and subsequently retreat the banknote toward a space 702, thereby to eliminate a stacking (discharge) failure state in which a banknote leading end is excessively protruded from the distal end edge of the dispense tray.

In a case where the length of the dispense tray in the discharge direction is reduced, a situation where a banknote emitted from the forming mechanism 550 lands at a too forward position on the dispense tray and the banknote drops out of the dispense tray is assumed. However, this problem can be solved because the guide members are means for latching an emitted banknote and moving the banknote backward in cooperation with the blades to prevent the banknote from being protruded excessively forward.

As illustrated in FIGS. 2 to 5 and 7, each of the guide members 710 is arranged on the upper surface of the dispense tray to interfere with the movement trajectory of the associated blades, is brought into contact (interferes) with the descending blades, and permits the blades to rotationally move (pass through) while elastically deforming the blades. Each of the guide members 710 includes a first contact part (an upper surface 716 and a rear end edge 716a) that is brought into contact with the rear part of a banknote being discharged by the forming mechanism 550 onto the dispense tray at a position higher than the upper surface of the dispense tray (in prior to the upper surface of the dispense tray), and a curved guide surface 720 that extends to be curved downward from the first contact part to the back (to the upstream side) in the discharge direction.

The positions and the width dimensions of the guide members are set to cause the guide members to be brought into contact with (the vicinity of) the both end parts of the rear part of a banknote in the width direction as illustrated in FIG. 5 and the like.

The rear part of a banknote in the present embodiment broadly includes a posterior half portion of a banknote with which the blades are contactable in the process of rotationally moving.

More specifically, as illustrated in FIG. 7 and the like, each of the guide members 710 generally includes a front protruded part 715 that has the rectangular and flat upper surface 716, the curved guide surface (a guide surface, a curved recessed place) 720 that continuously extends from the rear end edge (a corner edge part) 716a of the upper surface to be curved downward in a concave manner, and a rear part guide surface 722 that extends substantially horizontally from the rear end edge of the curved guide surface. The rear end edge 716a is a corner part extending linearly in parallel to the axial direction of the rotation shaft 552. The curved guide surface 720 extends to be curved downward and backward with the same width as that of the rear end edge 716a. The rear part guide surface 722 extends backward with the same width as that of the curved guide surface 720. While the rear part guide surface 722 is at a position slightly higher than the first upper surface 701 of the dispense tray in the present example, this is merely an example and the rear part guide surface 722 may be at substantially the same height unless the effect of sweeping in cooperation with the blades is impeded.

Since the upper surface 716 and the rear end edge 716a of the upper surface are at positions where the distal end part of each of the blades rotationally moving is brought into contact therewith, the distal end part of each blade passes while being elastically deformed and being brought into contact with a part of the upper surface 716 and the rear end edge 716a. To enable backward sweeping of a banknote in cooperation with the blades, the shapes and the positional relation of the curved guide surface 720 and the rear part guide surface 722 are also selected to enable the distal end part of each blade to move while being elastically deformed and being in contact therewith.

Experimentations were performed with guide members in each of which a flat surface inclined downward and backward from the rear end edge 716a is continuously provided instead of the curved guide surface 720 arranged on the dispense tray. While the function to sweep a banknote backward in cooperation with the distal end part of each blade was provided, the efficiency of sweeping was not so high as that of the curved guide surface.

As illustrated in FIG. 5(a), the guide members are configured to have a width twice as large as the width of each blade or larger, and to extend to outside in the axial direction beyond the outer flanges 607 and 609 to enable contact with the both end parts of a banknote B in the width direction. Accordingly, the guide members can be brought into contact with the both end parts of a wide banknote in the width direction and can guide the banknote.

### <Change Dispensing Operation Procedure>

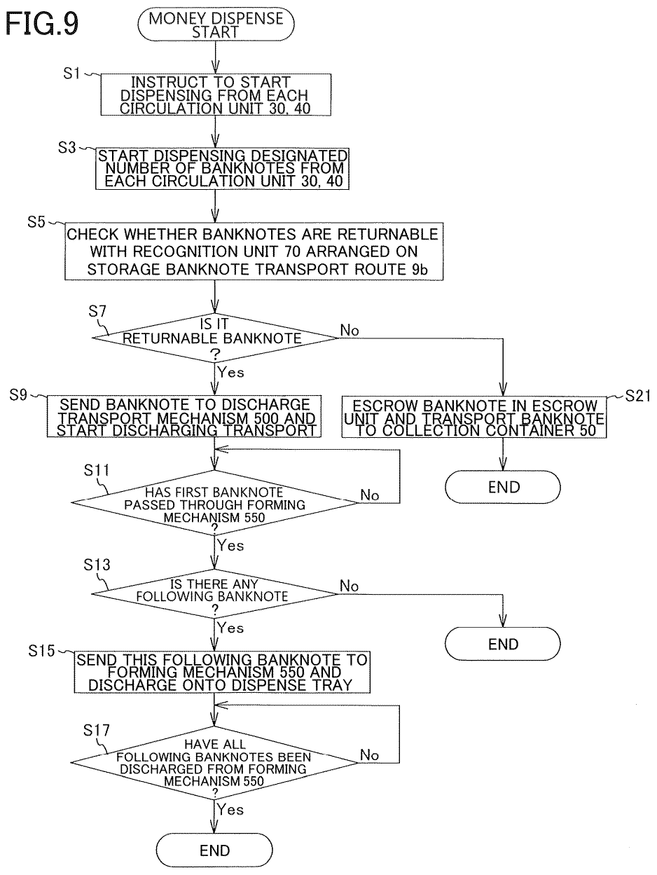

FIG. 9 is a flowchart for explaining the outline of a procedure of a change dispensing operation performed by the banknote processing device 1 of the present invention.

When receiving of input money and dispense of change are confirmed, dispense of change is performed in the procedure described below.

First, the control unit 1000 instructs each of the circulation units 30 and 40 to dispense a predetermined number of banknotes of the denomination stored therein (Step S1). For example, the control unit 1000 instructs the circulation unit 30 to dispense three of 1000-yen notes stored therein and instructs the circulation unit 40 to dispense one of 5000-yen notes stored therein as change to the dispense tray.

The circulation units 30 and 40 then start dispensing the designated numbers of 1000-yen notes and 5000-yen notes (Step S3). For example, three 1000-yen notes are successively dispensed from the circulation unit 30 and then one 5000-yen note is dispensed from the circulation unit 40.

The denominations of the banknotes dispensed one by one from the circulation units 30 and 40 are checked by the recognition unit 70 arranged on the storage banknote transport route 9b. When the banknotes are of the designated denominations, the banknotes are sequentially sent to the discharge transport stacking unit 500, and discharging transport of each of the banknotes is started (S5, YES at S7, and S9).

When it is judged at Step S7 that the banknote is unreturnable, the banknote is escrowed in the escrow unit and is transported to the collection container 50 (Step S21).

When it is detected by the tracking sensor 580 that a banknote B sent one by one to the discharge transport stacking unit 500 has passed through the forming mechanism 550 at Step S11 (YES at Step S11), whether there is any following banknote is judged at Step S13. When there is any following banknote, the following banknote is successively discharged by the discharge transport mechanism 520 (Step S15).

Further, whether all following banknotes have passed through the forming mechanism is checked at Step S17 and the processing ends when the passing is completed.

<<Comparison with Conventional Banknote Processing Device>>

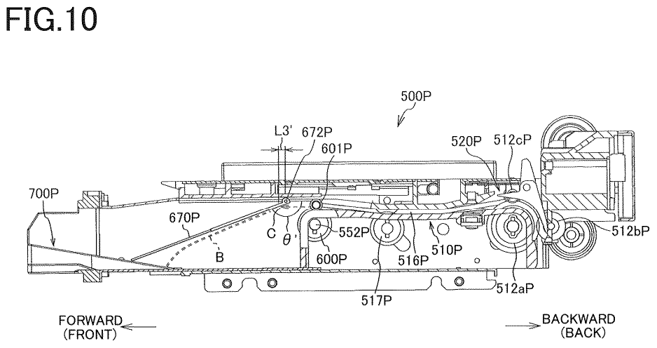

Next, to clarify the advantages of the present invention by comparison with a conventional example, comparative descriptions are made using a lateral vertical sectional view of a conventional discharge transport stacking unit 500P illustrated in FIG. 10.

The conventional discharge transport stacking unit 500P includes a discharge transport route 510P, a discharge transport mechanism 520P, a lever 670P, a discharge tray 700P, a discharging mechanism (a drive roller 600P, a tension roller 601P) for discharging banknotes onto the dispense tray, and the like. The discharging mechanism does not have a function to deform the short side shape of a banknote into a predetermined shape to correct a curling habit. A lever shaft 672P of the conventional lever 670P is positioned on the side of the dispense tray relative to (ahead of) a shaft 552P of the drive roller and the entire length of the lever is naturally shorter than that of the lever of the present invention. Accordingly, a banknote B transported on the discharge transport route 510P is brought into contact with the lever 670P and starts pushing up the lever after the leading end part of the banknote has passed through the discharging mechanism and is in contact with the lever. This discharging mechanism does not have a function to deform the short side shape of a banknote to increase the stiffness. Therefore, in a case where a banknote is limp or a curling habit inclined downward is formed on the leading end of the banknote, there is a risk that the banknote cannot sufficiently push up the lever and the banknote is buckled to cause a jam. That is, when upward pushing of the lever by a banknote is insufficient, there is a risk that the banknote cannot sufficiently move forward on the dispense tray and stops in a state of being buckled at a position considerably closer to the back (toward the right in FIG. 10) than the normal stop position on the dispense tray. Accordingly, it is difficult to stack a plurality of banknotes sequentially discharged on the dispense tray in a state where the banknotes can be easily taken out and are satisfactorily aligned.

In the conventional discharge transport stacking unit 500P, a banknote discharged from the discharging mechanism is brought into contact with the lower surface of the lever 670P ahead of the rotation shaft 552P and at a position (a contact point C) immediately close to the lever shaft (see FIG. 10). As a result, a distance L3′ from the lever shaft 672P to the contact point C between the lever and the banknote leading end is shorter and accordingly a greater force is required for a banknote to lift the lever. Therefore, a limp banknote cannot sufficiently push up the lever and is likely to be buckled at a position behind the normal stop position. Particularly, when the banknote leading end reaches the contact point C, the banknote is released from restraint by the transport roller 517P, the drive roller 552P, and the tension roller 601P and therefore returns to a limp state, and the banknote leading end is likely to be buckled downward as illustrated in FIG. 10. Subsequently, rear portions of the same banknotes sequentially released from the restraint by the rollers and discharged are also likely to be successively buckled.

Furthermore, since an initial angle θ′ of the conventional lever 670P in a lowered state is smaller, an even greater force is required for a banknote emitted from the discharging mechanism to push up the lever. Therefore, a limp banknote cannot sufficiently push up the lever and is likely to be buckled after being discharged. Alternatively, a limp banknote is likely to hit the rear part of an already-stacked banknote and push the already-stacked banknote to be dropped out of the dispense tray.

In contrast thereto, in the present embodiment, the lever shaft 672 is positioned behind the rotation shaft 552 and the lever 670 is elongated. The length of the lever 670 is set to enable the lever distal end part to be lowered and be brought into contact with an appropriate place of the upper surface (the base surface 701 in the present example) of the dispense tray in a state where no banknotes are on the dispense tray. This is because, if there is a space between the lever distal end and the upper surface 701 of the dispense tray, a banknote may slip through the space and jump out of the dispense tray.

In the present embodiment, the distance L3 (see FIG. 11(a)) from the lever shaft to the contact point C between the lever and a banknote can be set sufficiently long. Accordingly, a smaller force is required for a banknote to push up the lever and the lever can be more easily pushed up. Since the contact point C is positioned in the discharge transport route 510 (short of the forming mechanism), the leading end of a banknote at the time of reaching the contact point C is flattened by the transport guides 510a and the transport roller pair 517 and the stiffness thereof is temporarily increased. Therefore, the lever can be effectively pushed up.

Furthermore, with the configuration in which the distal end of the elongated lever 670 is brought into contact with the upper surface 701 of the dispense tray at the time of lowering of the lever, the initial angle θ at a time when the lever is lowered as illustrated in FIG. 11(a) can be increased and upward pushing at the time of banknote entry can be facilitated. Therefore, even a limp banknote can efficiently push up the lever.

In the present embodiment, to solve a trouble (an upward curling habit in the long edge direction) that a banknote being emitted toward the dispense tray cannot sufficiently push up the lever and descends by the weight of the lever, three points described below are devised.

That is, (1) the short side shape of a banknote is formed by the forming mechanism 550 into a predetermined shape (for example, a W shape) that enables the stiffness along the long edge direction of the banknote to be increased, (2) the weight of the lever is adjusted to an optimum value using the weight member 675, and (3) the lever lifting effect of a banknote is maintained by setting the width W1 of the central flange 605 to be sufficiently large.

First, as for (1), to form a banknote into a W shape across the entire length, it is preferable that the forming mechanism 550 (the nip parts n1 between the drive roller and the tension roller, and the flanges) continuously maintains a banknote in a horizontal or lifted attitude without lowering the banknote in a period until the rear end of the banknote has completely passed through the forming mechanism. With the forming mechanism, this function can be sufficiently provided. That is, since a banknote discharged from the forming mechanism onto the dispense tray 700 has an increased stiffness, the banknote is discharged while reliably pushing up the lever 670. That is, since a banknote is gripped by the flanges and the last roller pairs at a stage where the banknote is passing the forming mechanism, a banknote portion protruded ahead the forming mechanism can continue to maintain a state (the level of the stiffness) in which a curling habit has been corrected. Furthermore, also at a stage where the banknote has completely passed through the forming mechanism, the banknote maintains the state in which the curling habit has been corrected and falls at the normal position, and the banknote is finally held by the lever along with the already-stacked banknotes.

Next, as for (2), the consideration has been made based on the assumption that the banknote discharge stacking device M2 is a versatile model that can handle banknotes of countries across the world. That is, banknotes of various countries differ in the material, thickness, stiffness, weight, size, and the like, and the weight of the lever needs to be adjusted to enhance the stacking performance while addressing these differences. That is, if the lever is too lightweight relative to the weight of a banknote, the effect of holding already-stacked banknotes on the dispense tray at a time when the lever is lowered is decreased. On the other hand, if the lever is too heavy, there is a risk that the lever excessively presses down an emitted banknote. Therefore, fine adjustment of the weight of the lever with the weight member 675 is required.

Next, as for (3), to prevent corresponding portions of a banknote from sinking in the gaps G2 between the opening part 673 formed between the branch ends 670a of the lever and the central flange 605, the width W1 (FIG. 3) of the central flange is set sufficiently large. The reason for this setting is because, if a banknote penetrates and sinks in the gaps G2, the effect of pushing up the lever is deteriorated and there is a risk of buckling of the banknote on the dispense tray. This point will be described later.

Such considerations are not made at all in the conventional device configuration.

### <<Procedure of Dispense Banknote Processing Performed by Discharge Transport Stacking Unit>>

A procedure of processing a dispense banknote performed by the discharge transport stacking unit 500 (the forming mechanism, the stacking wheels, the banknote holding lever, and the guide members) is explained next with reference to FIGS. 11 to 14.

The base part 652 as a central part of each of the stacking wheels 650 is integrated with the rotation shaft 552, and rotates integrally with the drive rollers 555 and 600 and the flanges 605, 607, and 609. A conventional stacking wheel is used to slap a discharged banknote B with blades to prevent the banknote from jumping forward from the dispense tray. In contrast thereto, in addition to the conventional function, the stacking wheel of the present embodiment provides a function to drag backward a banknote being discharged one by one in cooperation with the guide member 710 provided on the dispense tray in the process of falling of the banknote.

FIGS. 11(a) to 11(d) are explanatory diagrams (lateral vertical sectional views) of an operation of the discharge transport stacking unit 500, sequentially illustrating states from when the leading end of a banknote B transported in the discharge direction in the discharge transport route 510 is brought into contact with the lever and until immediately after the leading end of the banknote has passed through the forming mechanism 550 while the banknote is pushing up the lever.

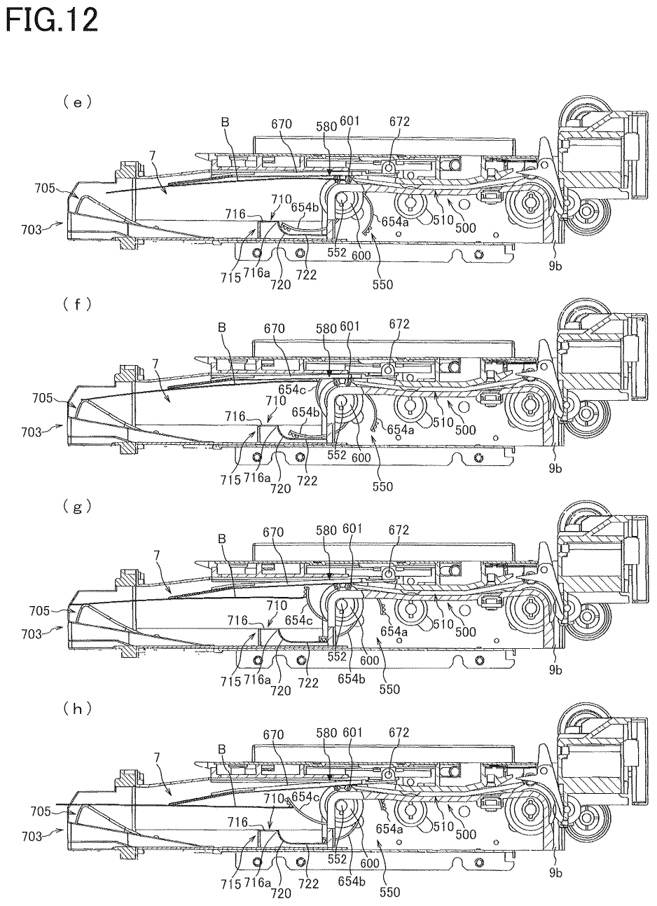

FIGS. 12(e) and 12(f) are explanatory diagrams (lateral vertical sectional views) of an operation of the discharge transport stacking unit 500, illustrating a state immediately before the rear end of the banknote B passes the forming mechanism and a state immediately after the passing. FIGS. 12(g), 12(h), 13(i) to 13(l), and 14(m) to 14(o) are explanatory diagrams of a process until a banknote falls on the dispense tray and an operation procedure performed by the blades to drag a banknote backward.

As the shape of a dispense banknote B illustrated in the drawings, only the shape of an end face of the banknote cut at a short side central part is illustrated. In other words, a state and a movement trajectory of a cut end face of a banknote corresponding to a short side central part (the protruded part P1) corresponding to the central flange 605 are illustrated. Therefore, states and movement trajectories of short side places (the protruded parts P2 and P3) corresponding to the drive rollers 555 and 600 and the outer flanges 607 and 609, and the oblique sides S1 and S2 are not illustrated.

A dispense banknote before entering the forming mechanism 550 is flattened by being pressurized from above and below by the transport rollers (transport members) 517 and the like in the discharge transport route. However, after the banknote passes through the forming mechanism, the short side shape is formed (provided with a habit) into a W shape along the long edge direction as illustrated in FIG. 6. Accordingly, an actual shape of a banknote positioned downstream from the forming mechanism is formed into a three-dimensional W shape. However, since a banknote is illustrated in a sectional view obtained by cutting a short side central part of a banknote across the entire length in FIGS. 11 to 14 as described above, a difference in the shape (the thickness in the vertical direction) of a banknote between before passing through the forming mechanism and after the passing is not represented.

Since the lever 670 is configured to be capable of moving the distal end part of the lever up and down without interfering with the central flange 605 although the lever shaft 672 is positioned behind the rotation shaft 552, the following behaviors are possible.

In FIG. 11(a), a banknote B that is discharged from any of the circulation units and that is transported on the storage banknote transport route 9b in an upturned attitude is guided to the discharge transport route 510 by the roller 512a that is rotationally driven in the counterclockwise direction to cooperate with the flapper 514 in an illustrated switch attitude. In FIG. 11(a), the leading end of the banknote is brought into contact with the lower surface of the lever 670 and starts pressing the lower surface at a position immediately before the forming mechanism 550, that is, a position immediately before the nip parts n1 between the drive rollers 555 and 600 and the associated driven rollers 556 and 601. That is, at a stage where a banknote has not reached the forming mechanism, the lever 670 descends by its own weight and is in contact with the upper surface of the dispense tray 700 at the distal end as illustrated in FIG. 11(a). By being pressed by the banknote at a place (the contact point C) with the distance L3 away from the lever shaft 672, the lever is pushed up as illustrated in FIG. 11(b). Since the lever shaft 672 is located behind the rotation shaft 552, the leading end part of the banknote can be brought into contact with the lever and start pushing up the lever at the position illustrated in FIG. 11(a) (a position upstream from the rotation shaft). Furthermore, since the sufficiently long distance L3 is provided between the lever shaft and the contact point C and the initial angle θ of the lever is set at a large angle close to 180 degrees, the lever can be pushed up with a small force.

In FIG. 11(c), since the movement of the banknote B in the discharge direction progresses from that in FIG. 11(b), the lever is pressed by the banknote and is further pushed up. However, the lever has not reached yet the lower surface of the frame 660 located thereabove. At this stage, the leading end of the banknote has not completely passed through the forming mechanism.

When a banknote passes the forming mechanism, the short side central part of the banknote moves along an upper part of the central flange 605, a short side portion corresponding to the drive roller 555, 660 passes the nip part n1 with the tension roller 556, 601, and a short side portion corresponding to the outer flange 607, 609 moves along an upper part of the outer flange. Timings when the short side portions move the corresponding parts are substantially the same. Completion of passing of a banknote through the forming mechanism indicates a state where the portions of the short side of the banknote have left all of the central flange 605, the nip part n1 between each of the drive rollers and the associated tension roller (the last roller pair), and the outer flanges.

At a subsequent stage in FIG. 11(d), the banknote is still compressively held (gripped) by the flanges and the last roller pairs constituting the forming mechanism while the leading end of the banknote passes through and moves a little ahead of the forming mechanism, so that the short side shape of a portion having completed the passing is formed into a W shape. Accordingly, the leading end portion of the banknote located downstream from the forming mechanism is in a state of being provided with a high stiffness and the lever is pushed up to a position where the lever is in contact with the frame 660 by the banknote leading end part having a high stiffness, and stops lifting. At that time, a banknote portion located downstream from the forming mechanism does not bow to pressing by the lever. Therefore, the attitude of this banknote portion is not inclined or curved downward and maintains a horizontal attitude or an upward inclined attitude.

In FIG. 12(e), the front portion of the banknote except for the rear part nipped by the nip parts n1 between the drive rollers and the associated driven rollers is entirely provided with a high stiffness by the forming mechanism and accordingly continues to push up the lever to the most lifted position while maintaining a substantially straight attitude as illustrated. That is, the banknote is discharged along the lower surface of the lever at the most lifted position. However, the leading end of the banknote has not lowered to the dispense tray at this stage.

FIG. 12(f) illustrates a state where the rear end of the banknote B has completely passed through the forming mechanism 550.

Even when the leading end of the banknote originally has a downward inclined curling habit formed thereon, the curling habit is eliminated at a stage where the banknote is discharged from the forming mechanism toward the dispense tray. Therefore, the banknote discharged on the dispense tray does not push the already-stacked banknotes to be dropped out of the dispense tray. That is, in the process from FIG. 12(e) to FIG. 12(f), the leading end of the following banknote is not brought into contact with the rear part or other portions of the already-stacked banknotes to push the banknote out of the dispense tray.

A curling habit has been removed also from the already-stacked banknotes by the forming of the forming mechanism and the banknotes maintain a straight and flat attitude across the entire length. Therefore, the already-stacked banknotes do not cause unwanted interference with the following banknote.

At subsequent stages illustrated in FIGS. 12(g) and 12(h), the leading end of the banknote is protruded from the distal end of the dispense tray. If this state is left untreated, the banknote may drop out of the dispense tray. In a case where there is a request for reducing the length of the second unit M2 in the front-back direction, the length of the dispense tray in the front-back direction is reduced and the phenomenon described above is likely to occur. In this case, the leading end of the banknote having been formed by the forming mechanism and emitted therefrom is likely to be greatly protruded from the front end edge of the shortened dispense tray and to drop when the banknote lands the dispense tray while being held by the lever.

To solve this trouble, the present invention is configured in such a manner that the space 702 for retreat is formed at a rear part of the dispense tray 700 at a point of time when the banknote has landed in a state of being greatly protruded from the distal end edge (the retractable members 705 in this example) of the dispense tray as illustrated in FIGS. 12(g) and 12(h). The guide members 710 as projections are fixedly arranged on the upper surface of the dispense tray corresponding to the space 702 for retreat at the positions corresponding to the movement trajectories of the blades 654 of the stacking wheels. With the cooperative operation of each of the guide members and the associated stacking wheel, the banknote B once discharged on the dispense tray is retreated toward the space 702, thereby eliminating the state in which the leading end of the banknote is protruded from the distal end edge of the dispense tray.

The arrangement and the height of each of the guide members 710 are configured to enable sweeping with the blades to be started at a stage where the rear part of the banknote being falling on the dispense tray is in the air before falling on the upper surfaces 716 or the rear end edges 716a of the guide members as illustrated in FIGS. 12(g) and 12(h). That is, the arrangement and the height are configured to cause a first contact between a falling banknote and blades to be performed at a point of time when the banknote is in the air.

Due to variation in the behavior of banknotes, the distal ends of blades may be brought into contact with a banknote rear part after the banknote rear part falls on the upper surfaces of the guide members or at the same time as the falling. It has been confirmed that the banknote can be swept backward without any problem also in this case.

The length and the positional relation of each of the blades 654c are set to enable the blades to be always brought into sliding contact with the outer surfaces of the guide members 710 in the process of rotationally moving.

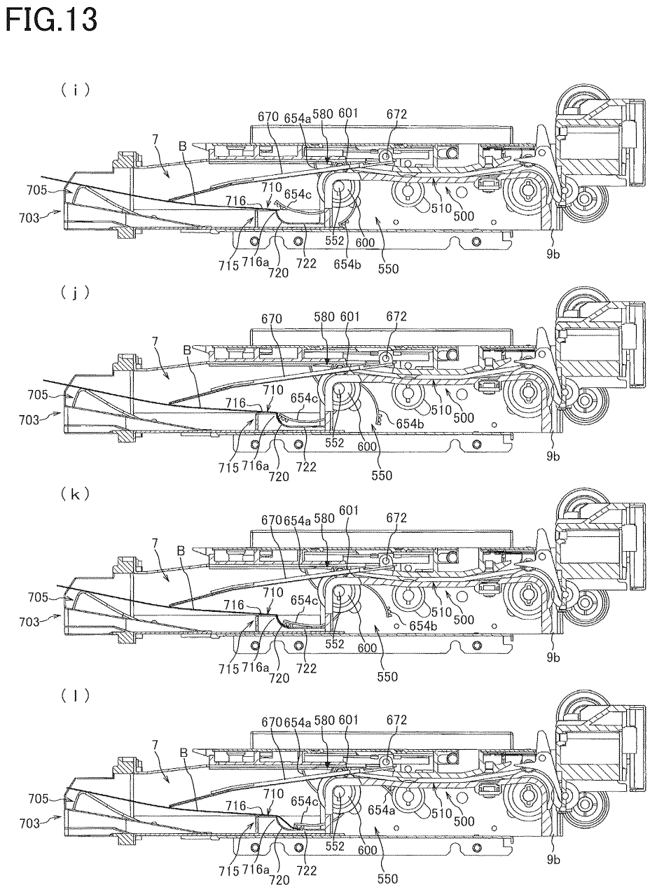

The rotation speed of the stacking wheels, the rotation timing of the blades with respect to a discharged banknote, and the length of the blades (the rotation trajectory of the blade ends) are selected to enable the blades 654c rotationally moving from above to trap the rear part of a banknote being discharged onto the dispense tray and to pull down the rear part toward the guide members 710 as illustrated in FIGS. 12(g), 12(h), 13(i), and 13(j). The positions of the guide members in the front-back direction on the dispense tray, the length of the upper surfaces 716 in the front-back direction, and the positions of the rear end edges 716a in the front-back direction are selected to enable the rear part lower surface of a banknote pulled down by the blades 654c to be easily brought into contact with the upper surfaces and the rear end edges of the guide members as illustrated in the drawings described above.

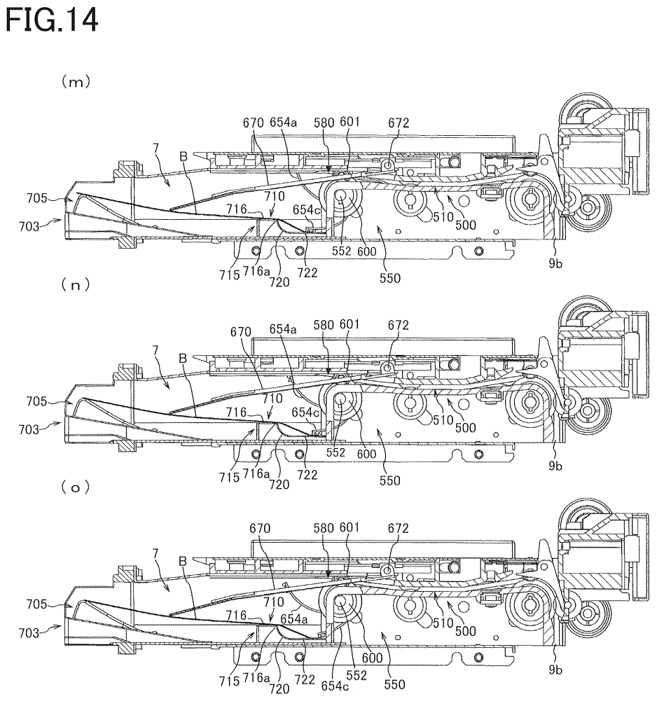

With this configuration, even when a discharged banknote is excessively protruded forward, the blades 654c can trap the rear end of the banknote in the air at an early time during discharge of the banknote and can start sweeping the banknote downward and backward. It is also possible that the blades 654c can start nipping the lower surface of the rear part of the banknote with the rear end edges 716a of the guide members at a point of time when the blades have reached the rear end edges 716a, and can thereafter draw the entire banknote backward while nipping the banknote between the distal ends of the blades and the curved guide surfaces 720 (FIGS. 13(k), 13(l), and 14(m) to 14(o)).

Since a banknote with the rear end having left the forming mechanism 550 descends while being pressed down by the lever 670 at stages illustrated in FIG. 12(g) and subsequent figures, the banknote can be drawn backward while being lowered by the cooperation of the lever and the blades.

More specifically, to increase the processing speed for dispense banknotes, the present invention is configured in such a manner that, before a banknote discharged from the forming mechanism 550 has completely fallen on the upper surface of the dispense tray or the guide members 710 at a stage where the rear part of the banknote is in the air (FIGS. 12(g) and 12(h)), the distal end parts of the blades 654c are brought into contact with the rear part of the banknote. By appropriately selecting or setting the timing of contact between the blades and each banknote in this manner, in other words, the rotation speed of the blades and the emitting speed of banknotes, an operation of forcibly drawing a banknote in the lowering direction and toward the back can be started at a point of time when the banknote rear part being in the air is brought into contact with blades. Subsequently, at a point of time when the blades are lowered to a position where the blades are in contact with the upper surfaces and the rear end edges of the guide members, the banknote rear part is in a state of being nipped between the blades and the guide members. Therefore, the banknote is reliably pulled backward along the curved guide surfaces 720 by the subsequent rotating operation of the blades. Therefore, all banknotes are stacked in a state where the rear ends are aligned on the dispense tray regardless of differences in the size in the long edge direction, and are prevented from dropping from the distal end edge of the dispense tray.

In the present embodiment, a banknote being discharged onto the dispense tray is pulled backward after the leading end part is caused to temporarily land on the dispense tray (on the retractable members 705) as illustrated in FIGS. 12(g) to 14(o). When this phenomenon is seen from the side of the return port, the banknote acts to be temporarily discharged in a state of being protruded from the front end edge of the dispense tray and to be pulled backward immediately thereafter and stop.

The falling route and the falling timing of a banknote increased in the stiffness by the forming mechanism 550 are relatively stable and constant. However, in the case of a banknote having an extremely strong upward curling habit or a so-called crumpled banknote where the original stiffness is significantly decreased, there is a risk that the falling route and the falling timing vary also after the forming by the forming mechanism is performed. Accordingly, the timings when blades trap the banknote rear part in the air are not always the same. The banknote rear part may fall onto the guide members before blades are brought into contact therewith. However, according to the present embodiment, blades can nip the banknote rear part with the guide members to sweep the banknote backward also in this case.

More specifically, the configuration, the rotation timing, and the like of the stacking wheels are set to slap an emitted banknote downward. Particularly, in the present embodiment, the stacking wheels can be designed to enable a banknote having the short side shape formed into a W shape by the forming mechanism 550 and emitted therefrom to be brought into contact with blades in the air in the process of falling as long as a curling habit before the forming is at a normal level. However, when the upward curling habit in the long edge direction of a banknote is extremely strong, there may be a case where a sufficient stiffness cannot be provided because a complete W shape cannot be formed by the forming mechanism across the entire length of the banknote. In such a case, a situation where the curling habit returns at the moment when the banknote exits the forming mechanism, the banknote rear end is curled away from the blades, and the banknote rear end falls on the guide members 710 before being brought into contact with the blades may occur. However, according to the configuration of the present embodiment, also in this case, the banknote rear part is caught on the guide members to be blocked from moving forward and is trapped to be swept backward by the distal end of a subsequently descending blade. As a result, dropping of the banknote out of the dispense tray is prevented.

A crumpled banknote where the stiffness is considerably decreased can be processed in the same manner.

In the light of the above configurations and functions of the stacking wheels 650, the lever 670, the guide members 710, and the like, the operation of the stacking wheels to draw a banknote discharged from the forming mechanism 550 backward in the process where the lever pushes the banknote downward is further described next.

As illustrated in FIGS. 12(g) and 12(h), when blades 654c rotating downward are brought into contact with the rear part of a banknote B discharged from the forming mechanism 550 onto the dispense tray while the banknote rear part is still in the air, the high friction region 656 reliably traps the banknote and starts the operation to forcibly sweep the banknote downward and backward in corporation with the pressing-down operation of the lever. That is, since the banknote discharged from the forming mechanism is biased forward, the banknote is attempting to move in the air toward the distal end edge of the dispense tray 700. By bringing blades 654c moving downward with respect to the rear part of the banknote being in the air illustrated in the drawings into contact with the banknote, momentum of the banknote to advance can be reduced to stop the movement of the banknote in the advancing direction and then the banknote can be further guided to the direction (downward and backward) in which the blades 654c rotationally move.

In the illustrated embodiment, the configuration example in which the novel lever 670 having the lever shaft 672 arranged upstream from the forming mechanism in the discharge transport route 510 is used is described. However, this is an example and a conventional lever (FIG. 10) having the lever shaft arranged outside the terminal end part of the discharge transport route, that is, above the dispense tray may be used. That is, also in a discharge transport stacking unit including the conventional lever, the banknote sweeping effect can be obtained by application of the stacking wheels and the guide members 710.

When the blades 654c continue the downward rotation after trapping the rear part of the banknote B being in the air in FIGS. 12(g) and 12(h), the blades 654c push the banknote rear part downward until the rear part is brought into contact with the upper surfaces 716 and the rear end edges 716a of the guide members 710. At this point of time, the banknote rear part is in a state of being compressively held between the high friction region 656 and the rear end edges 716a. Therefore, by the blades further continuing the rotational movement, the banknote is moved backward along the curved guide surfaces 720 and the rear part guide surfaces 722 as sequentially illustrated in FIGS. 13 and 14.

At the point of time illustrated in FIG. 14(o), the blades 654c are almost separate from the banknote rear end and accordingly the backward movement of the banknote stops. A stopper for aligning the rear ends of banknotes swept backward may be provided at the terminal end part of the space 702 for retreat as required.

As described above, the blades 654c are brought into contact with the rear part of a banknote discharged from the forming mechanism at a position ahead of and above the upper surfaces 716 of the guide members at an earlier timing than falling (contacting) of the rear part on the upper surfaces 716, and start sweeping the banknote to be returned downward and backward (in the opposite direction to the banknote emitting direction). In other words, the contact position C between each of the blade distal ends and a banknote can be set to a farther position on the rotation trajectory of the blade distal end. Accordingly, it is possible to start sweeping the banknote backward at an earlier stage before the banknote has completely landed on the dispense tray and therefore the processing speed of banknote stacking can be increased.

Furthermore, with provision of the guide members 710, the rear part of a banknote in the course of falling can be brought into contact with the rear end edges 716a of the guide members when the rear part is at a position upper than the upper surface 701 of the dispense tray. That is, the banknote rear part can be caught on the rear end edges 716a at an early timing before the banknote rear part lands on the dispense tray. Accordingly, a banknote once having landed on the dispense tray in a state of being protruded from the front end edge of the dispense tray can be promptly pulled backward and can be stopped at the optimum position.

According to the above configuration, the rear ends of all banknotes discharged onto the dispense tray can be sequentially aligned regardless of the size of the banknotes in the long edge direction. Therefore, while the banknotes are prevented from being excessively protruded from the distal end edge of the dispense tray or dropping out therefrom, a plurality of banknotes stacked on the dispense tray can be brought to the optimum state for a user to take out the banknotes collectively.

There is a strong request to downscale and shorten the dispense tray as much as possible. Such a request can be met because the rear ends of discharged banknotes can be aligned with respect to the back part of the dispense tray.

A configuration and an operation of the guide members and the stacking wheels according to the present invention to draw (sweep) a banknote backward are described in more detail next in comparison with the configuration and the operation of a conventional stacking wheel.

A stacking wheel used to hold a banknote being emitted to the dispense tray conventionally only has an object to suppress a banknote from jumping out to the front by pressing of the banknote to the dispense tray with blades rotating downward. That is, the conventional blades only have a function to hold down an emitted banknote to prevent the banknote from floating and jumping out to the front, and hold down a banknote after the banknote has landed on the upper surface of the dispense tray or immediately before the landing. Furthermore, the distal end part of each blade starts rotationally moving toward the back while being elastically deformed after a point of time when the blade nips the banknote and is brought into contact with the upper surface of the dispense tray. However, since the upper surface of the dispense tray is a flat surface, the banknote cannot be moved backward even when the distal end part of the blade moves backward. That is, after the distal end part of a blade of the conventional stacking wheel is brought into contact with a banknote, the distal end part of the blade only moves backward while sliding on the upper surface of the banknote located between the distal end part and the upper surface of the dispense tray, and the conventional stacking wheel does not have a function to draw the banknote landed on the dispense tray to the back.

In contrast thereto, in the present embodiment, when a banknote is emitted from the forming mechanism 550, the distal ends of blades are brought into contact with the banknote rear part at a timing sufficiently earlier than landing of the banknote on the upper surface of the dispense tray, that is, at an appropriate early timing immediately after the banknote is emitted, to start deceleration of the banknote and change of the direction. Subsequently, the stacking wheels continue to lower the banknote toward the back also in a period until the rear surface of a banknote portion being in contact with the blade distal ends is brought into contact with the upper surfaces or the rear end edges (located at a higher position than the upper surface of the dispense tray) of the guide members. After a point of time when the blade distal ends start nipping the banknote with the front protruded parts 715 of the guide members, the whole banknote can be smoothly moved downward and backward along the curved guide surface 720.

The distal ends of the blades start elastically deforming while nipping the banknote with the hard guide members 710. In the course where the banknote leading end sequentially moves through the rear end edges 716a of the guide members to the curved guide surfaces 720 and the rear part guide surfaces 722 while being elastically deformed, the distal ends of blades increase the contact area with the banknote face while elastically deformed into a shape along parts of the guide members (without causing sliding between the banknote and the blade distal ends) and can provide a longer time to sweep the banknote while being in contact therewith. That is, the area where the distal end parts of the blades are in contact with a banknote increases and the press contact force is increased. Therefore, the force to sweep the banknote is increased and reliable sweeping without sliding between the banknote and the blades is enabled.

Furthermore, the conventional stacking wheel does not have the effect of drawing an emitted banknote in a direction opposite to the emitting direction and there has been no concept itself of providing the effect of drawing a banknote in the opposite direction with blades. In contrast thereto, in the present invention, each of the guide members having the upper surface higher than the upper surface of the dispense tray is provided at a position interfering with blades, so that the effect of reliable drawing in cooperation with the guide members and the blades is realized.

The falling position of a banknote being emitted from the nip parts n1 of the drive roller and the tension roller onto the dispense tray may vary in the front-back direction according to conditions such as the intensity of a curling habit of the banknote. However, in the present invention, a banknote that is falling farther can be trapped in the air by blades of the stacking wheels and can then be swept in the opposite direction to the emitting direction in cooperation with the guide members. In a case where the guide members are not provided, blades hold a banknote on the flat upper surface of the dispense tray and accordingly a force to draw the banknote backward is not generated while a force to press the banknote downward (a force to stop the banknote) can be provided.

Particularly, the guide members according to the present embodiment each have the curved guide surface 720 continuously provided from the rear end edge of the upper surface and curved and lowered from the upper front to the lower back, and this curved surface substantially matches the rotation trajectory of the blades. Therefore, the guide members afford sweeping of a banknote while sliding the banknote backward.

The curved shape of the curved guide surface 720 is configured to overlap with the circular trajectory of the distal end parts of the blades on the rotation shaft 552. The curvature radius of the curved guide surface is configured to be smaller than the curvature radius of the circular trajectory of the distal end parts of the blades. However, it is also possible that the curved guide surface is not arc-shaped and it suffices that the curved guide surface has a curved shape that enables a banknote to be smoothly guided backward while the banknote rear part is nipped with the distal end part of a blade.

With setting of the frictional resistance of a face on which the guide members 710 are in contact with a banknote to be small (smaller than the frictional resistance against the upper surface of the dispense tray), slipping between a banknote and the guide members can be improved and movement of the banknote to the back can be smoothened.

In the second unit (the banknote discharge stacking device, the collective dispensing unit) M2 including the forming mechanism 550, the forming is performed to increase the stiffness of a banknote emitted onto the dispense tray and incline the right and left end parts of the short side upward. Therefore, even when the guide members 710 are not provided, it is possible to prevent the following curved banknote from dropping an already-stacked banknote or the curved banknote itself from dropping out of the dispense tray. Accordingly, in a case where the forming mechanism is provided, the guide members are not constituent requirements to prevent dropping of a curved banknote from the dispense tray.

However, the action on a banknote by cooperation of the guide members and the blades is useful in view of enhancing the performance of aligning banknotes on the dispense tray or ensuring prevention of dropping.

A situation where the stacking wheel blades rotationally moving without any interruption hold the rear parts of already-stacked banknotes with the guide members is also a factor that overcomes the trouble of pushing-out of the already-stacked banknotes by the following banknote.

While correction of a banknote having an upward curling habit has been described as an advantage of the forming mechanism 550 according to the above embodiment, it is needless to say that the forming mechanism also has a function to correct a downward curling habit of a banknote.

### <<Measures for Banknotes Having Decreased Stiffness>>

In a case where the forming mechanism 550 is not provided in the discharge transport stacking unit 500, that is, a case where the flanges 605, 607, and 609 are not provided, a banknote having a low stiffness is discharged onto the dispense tray from the nip parts n1 of the last roller pairs (the drive roller 555, 600 and the tension roller 556, 601). In this configuration, a banknote having a low stiffness after being discharged needs to advance only with its own stiffness and fall on the dispense tray while lifting the lever 670 with the stiffness. A banknote having a stiffness lower than a predetermined level is crushed by the lever and cannot move forward beyond the lever.

That is, if the flanges 605, 607, and 609 are not included, when a banknote having a stiffness lower than a predetermined level is transported on the discharge transport route 510, the banknote cannot sufficiently push up the lever 670 and land at an appropriate position on the dispense tray 700 in the course of being discharged on the dispense tray, regardless of whether the banknote includes a curling habit. In other words, since the lever is not completely lifted and maintains a low attitude during the discharge, the banknote cannot move forward beyond the lever and is brought to a state of being crushed by the lever. Accordingly, a banknote having a low stiffness is likely to be buckled in a narrow space between the lower surface of the lever remaining lowered and the upper surface of the dispense tray. When a plurality of banknotes are to be discharged as change, one banknote having a low stiffness causes a discharge failure or an alignment failure of the following banknotes.

In the present embodiment, the trouble described above can be overcome because the stiffness of a banknote having a stiffness decreased to be lower than a predetermined level can be increased by the forming mechanism 550.

Furthermore, as already described, since the lever shaft 672 is arranged upstream from the drive shaft (the rotation shaft) 552 of the last roller pairs and a banknote is transported by the transport rollers 517 in the advancing direction with a great force, even a banknote having a significantly low stiffness can push up the lever with a great force.

The weight of the lever 670 and the initial angle of the lever (the inclined angle at the time when the lever is most lowered) are also set to enable a banknote having a stiffness decreased to be lower than a predetermined level to lift the lever. As one example, the weight of the lever exclusive of the weight 675 is about 10 grams and the initial angle θ is about 21 degrees.

### Banknote Discharge Transport Device: Second Embodiment

With the banknote discharge stacking device M2 according to a second embodiment, even a considerably degraded banknote (a crumpled banknote) can be discharged and stacked in a normal state on the dispense tray while the banknote is formed into a required shape by the forming mechanism 550 to increase the stiffness.

When the degree of decrease in the stiffness of a dispense banknote B is great, that is, when the banknote is crumpled, the stiffness cannot be sufficiently increased to be as high as the normal banknote having a sufficiently high stiffness even when the forming mechanism 550 attempts to form the short side shape of the banknote into a predetermined shape.

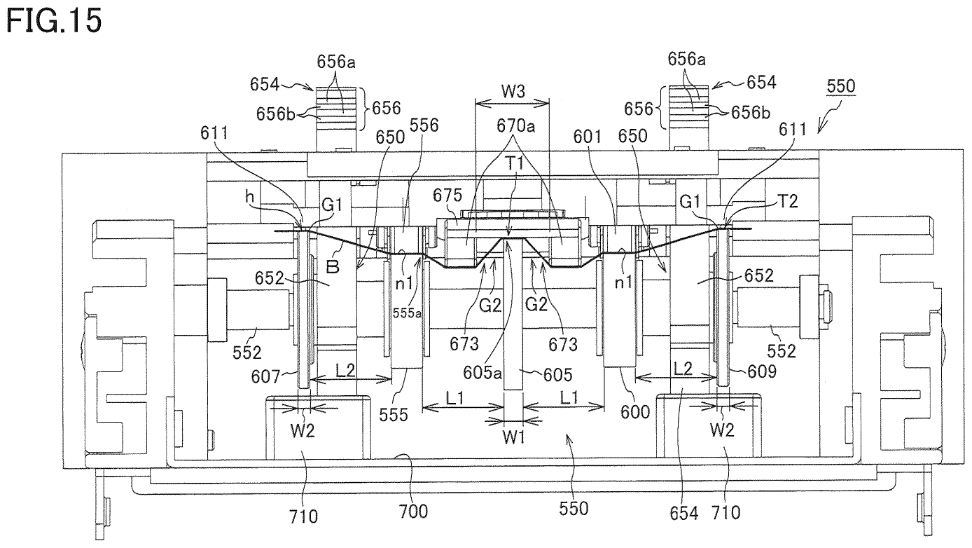

FIG. 15 is a comparative example representing a configuration example in which the gaps G2 in the banknote discharge stacking device are enlarged, and is a partial sectional front view illustrating a state in which a banknote having a stiffness greatly decreased passes the forming mechanism in which the excessively large gaps G2 are set.

When the intervals (the gaps G2) between the opening part 673 between the branch ends 670a at the lever distal end and the central flange 605 are excessively large at a time of passing of a banknote having a greatly decreased stiffness through the forming mechanism 550, in other words, when the flange width W1 is too small relative to a width W3 of the opening part 673, the gaps G2 become large. Accordingly, as illustrated, a part of a banknote sinks in (digs into) the gaps G2, which makes difficult to push up the lever. That is, a banknote having a greatly decreased stiffness is likely to be crushed at a leading end edge portion corresponding to each of the gaps G2 and to enter the gaps G2 before pushing up the lever. Further, the subsequent portion of the banknote is also crushed and enters the gaps G2 in association with advance following the leading end. Accordingly, the stiffness of portions having entered the gaps G2 is decreased and the force (intensity) to push up the lever is lowered.

As specific values, it is expected that a crumpled banknote sinks to a depth of around 2.5 mm in each of the gaps G2 and the height position of the lever on the rotation shaft 552 is lowered by 2.5 mm due to occurrence of the sunk portions. Accordingly, the lever is correspondingly turned downward by an angle of about 7.5 degrees. In other words, without 2.5 mm of entry into the gaps, the lever is in the original attitude upward by the angle of 7.5 degrees. When the banknote cannot sufficiently push up the lever and the angle of the lever decreases in this way, the risk that the banknote causes buckling to jam when being brought into contact with the upper surface of the dispense tray increases.

This problem is described based on a relation between the central flange 605 and the drive roller 555 illustrated in FIG. 15. As the distance between an upper corner part 605a of the central flange and an upper corner part 555a of the drive roller is shorter, the force (stiffness) to hold a banknote portion located between the corner parts becomes greater. As compared to the distance between the corner part 605a of the central flange 605 and the corner part 555a of the drive roller 555 according to the first embodiment illustrated in FIG. 3, the distance of the corresponding portion in FIG. 15 is considerably long. Accordingly, in the configuration example of FIG. 15, a banknote is more likely to enter the gaps G2. If a banknote enters the gaps G2, the banknote has a saggy shape and the angle of the lever is decreased by the banknote having entered the gaps. This applies equally to the relation between the central flange 605 and the other drive roller 600.

### <Discharge Transport Stacking Unit>

In the discharge transport stacking unit 500, to address this trouble, the relation between the opening part 673 of the lever distal end and the central flange 605 is optimized.

Other characteristic configurations of the discharge transport stacking unit 500 are described below with reference to FIGS. 3 to 5.

In the forming mechanism 550, to prevent a part of a banknote having a greatly decreased stiffness from sinking into the gaps G2 formed between the both inner edges of the opening part 673 of the lever and the both outer surfaces of the central flange 605, the ratio of the width W1 of the central flange and the width W3 of the opening part is set.

Along with the forming into a W shape by the forming mechanism 550, the central flange is configured to be wide to appropriately narrow the gaps G2, whereby the level of the stiffness is increased to such an extent that even a crumpled banknote can push up the lever and improve the stacking performance, and the banknote can be discharged in an upturned attitude.

As a configuration example of an actual device, when the width dimension W1 of the central flange was 6.0 mm and the width dimension W3 of the opening part 673 of the lever was 9.2 mm, sinking of a crumpled banknote was surely prevented and the buckling prevention effect for banknotes was sufficiently provided. According to experimentations, the optimum value of the ratio of the width dimension W1 of the central flange to the width dimension W3 of the opening part was about 0.65. In this dimension example, the values of the right and left gaps G2 are each 1.6 mm.

As described above, in the present invention, while the width W3 of the opening part of the lever is fixed, the width W1 of the central flange is made larger than the width of the outer flanges to set the gaps G2 to be appropriately small, thereby preventing a banknote from sinking therein. Accordingly, even a crumpled banknote having a greatly decreased stiffness is pushed up by the outer circumferential surface of the central flange to increase the shape holding property (the stiffness) to enable the lever to lift. In other words, with the dimension adjustment of the gaps, the backup function provided by the wide outer circumferential surface of the central flange is enhanced and a state where the stiffness of a crumpled banknote is superior to the weight of the lever can be obtained.

When the weight 675 of 20 grams is fixed on the distal end of the lever, a banknote needs to lift the lever including this weight. Since the lever shaft 672 is positioned behind the rotation shaft 552, the banknote can lift the lever by backup of the central flange.

From the above descriptions, a banknote having a greatly decreased stiffness, that is, a crumpled banknote can be defined as a banknote that is weakened to such an extent that, when the ratio of the width W1 of the central flange to the width W3 of the opening part of the lever distal end is small to be lower than a predetermined value (for example, about 0.65), a part of the banknote causes sinking into the gaps G2 therebetween. That is, even if the weakness (decrease in the stiffness) of a banknote progresses, the stiffness can be sufficiently increased by forming of the banknote into a W shape when the weakness is at such a level that does not cause sinking of a part of the banknote into the excessively large gaps G2 and therefore, even if the gaps G2 are large, a part of the banknote does not sink therein. Even when a banknote is weakened to such an extent that a part thereof sinks into the excessively large gaps G2, the banknote can be discharged while pushing up the lever by increase in the stiffness due to forming of the banknote into a W shape and the backup effect on the banknote by the central flange when the ratio of the width W1 of the central flange to the width W3 of the opening part of the lever distal end is set to enable the gaps G2 to have an optimum value (for example, the ratio is set at about 0.65 or higher).

When a banknote is formed into an M shape, the both ends of a wide banknote are inclined downward and are likely to hang down and to hit against an already-stacked banknote. Particularly, it is apparent that the both end parts of a banknote where the short side is long are likely to hang down due to the weight even when a central part and both outer portions are gripped by the central flange and the roller pairs.

When a banknote is formed into a W shape, the both end sides S2 of the short side are inclined upward and the top parts P3′ are gripped by the outer flanges and are accordingly less likely to hang down. Since there is a ceiling (the frame 660) in actuality, the both end sides S2 hit the ceiling and are slightly lowered, so that the banknote is transported along the ceiling. However, the both end sides S2 do not greatly hang down to such an extent as to interfere with the already-stacked banknotes.

### Banknote Discharge Stacking Device: Third Embodiment

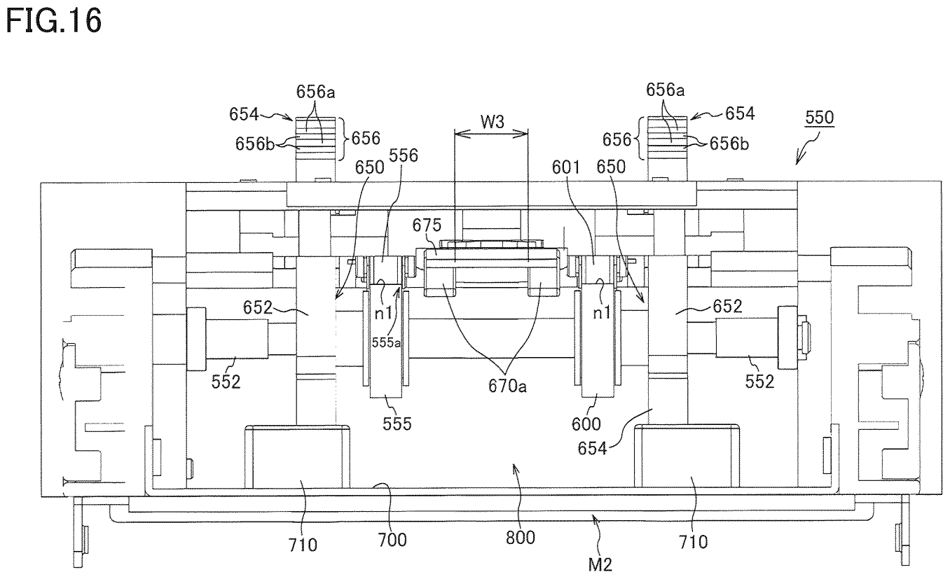

FIG. 16 is a front view of relevant parts of the banknote discharge stacking device M2 (a discharge transport stacking unit 800) according to a third embodiment.

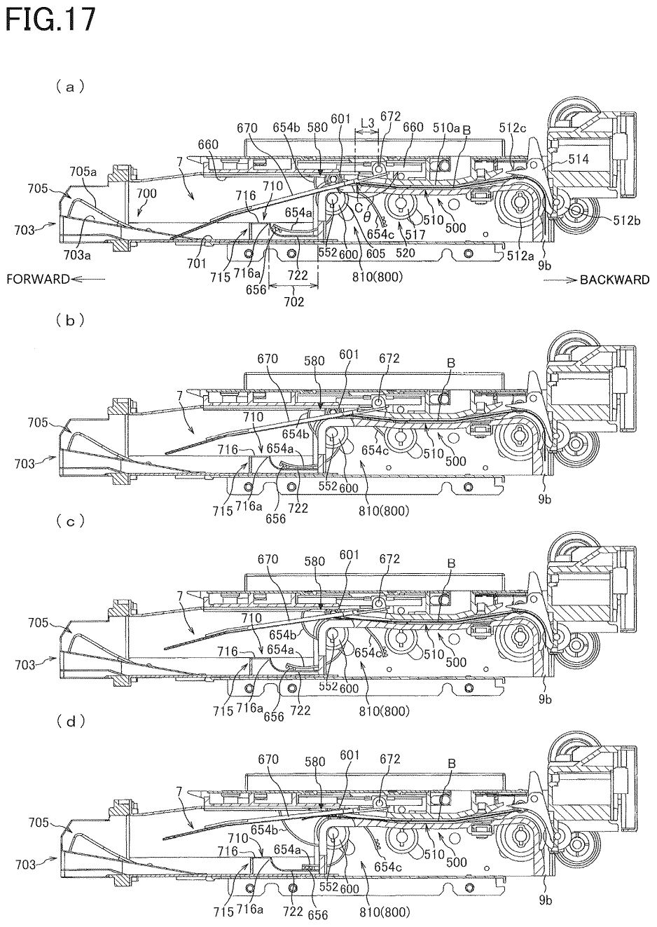

FIGS. 17 to 20 are lateral vertical sectional views for explaining a configuration of the banknote discharge stacking device M2, and a discharging and sweeping operation thereof. Like parts as those of the discharge transport stacking unit according to the first embodiment are described with the same reference signs.

The banknote discharge stacking device M2 according to the third embodiment enables a banknote being discharged in a state of having a curling habit onto the dispense tray to land in a aligned manner in cooperation with the stacking wheels 650 and the guide members (the guide protruded parts) 710 while the forming mechanism according to the first embodiment is not included in the configuration.

In the present embodiment, while a banknote having a curling habit is discharged in a state where the curling habit returns at the time of discharge onto the dispense tray, a trouble that the banknote drops out of the dispense tray or pushes out an already-stacked banknote by inter-banknote friction to be dropped can be overcome.

### <<Basic Configuration>>

The banknote discharge stacking device M2 has a basic configuration described below.

That is, the discharge transport stacking unit 800 constituting the banknote discharge stacking device M2 is means for discharging banknotes dispensed one by one from the circulation units 30 and 40 that receive and store banknotes and that dispense stored banknotes to outside, onto the dispense tray one by one and for stacking the banknotes, and includes the discharge transport route 510 on which a dispense banknote is discharged and transported, the discharge transport mechanism 520 that provides a dispense banknote B (hereinafter, “banknote B”) on the discharge transport route with a transport force, a last discharging mechanism (hereinafter, “discharging mechanism”) 810 that is located at a downstream part of the discharge transport route and that discharges a dispense banknote onto the dispense tray, and the dispense tray 700 on which banknotes discharged from the discharging mechanism are stacked.

The discharging mechanism 810 includes the rotation shaft (drive shaft) 552 that is arranged orthogonally to the transport direction of the dispense banknote B and that is rotationally driven in the discharge direction, and the last roller pairs constituted of the drive rollers 555 and 600 that each have an axis fixed to the rotation shaft, and the driven rollers 556 and 601 that each form the nip part n1 for banknote transport with the associated drive roller.

The banknote holding lever 670 has a rear part supported about an axis on the lever shaft (parallel to the rotation shaft) 672, which is arranged upstream from the rotation shaft 552 in the discharge direction, to be pivotable in the upper-lower direction, and the banknote holding lever is configured to enable a front part to be in contact with the upper surface of the dispense tray (or the upper surface of an already-stacked banknote) by its own weight when at the most lowered position.

In the process in which a banknote B passes the discharging mechanism 810, the banknote holding lever 670 pivots up and down by an action of a banknote passing through while being in contact with the lower surface of the lever 670.

The stacking wheel 650 is arranged on each of both outer sides of the drive rollers 555 and 600 in the axial direction, with the axis of the stacking wheel fixed to the rotation shaft 552.

The guide members (the guide protruded parts) 710 as upward projections that are brought into contact with blades 654 and allow rotational movement (passing) thereof while elastically deforming the blades are provided on the upper surface of the dispense tray that interferes with the movement trajectory of the blades.

Since there is no difference in the configurations of the stacking wheels and the guide members from those in the first embodiment, redundant descriptions thereof are omitted.

### <Discharge Transport Stacking Unit>

The discharge transport stacking unit 800 is explained in detail below.

The discharge transport stacking unit 500 according to the first embodiment has the forming mechanism 550 including the drive rollers 555 and 600, the tension rollers 556 and 601, and the flanges 605, 607, and 609. That is, banknotes discharged on the dispense tray are all in a state where a curling habit in the long edge direction is eliminated or reduced by the forming mechanism.

In contrast thereto, the discharge transport stacking unit 800 according to the third embodiment only includes the discharging mechanism constituted of the drive rollers 555 and 600, and the tension rollers 556 and 601. Since not having the flanges 605, 607, and 609, the discharging mechanism 810 does not have a function to form the short side of a banknote into a predetermined shape to increase the stiffness. The stacking wheels 650 each have an axis fixed to the rotation shaft 552 of the drive rollers and are arranged on the both sides of the drive rollers in the axial direction.

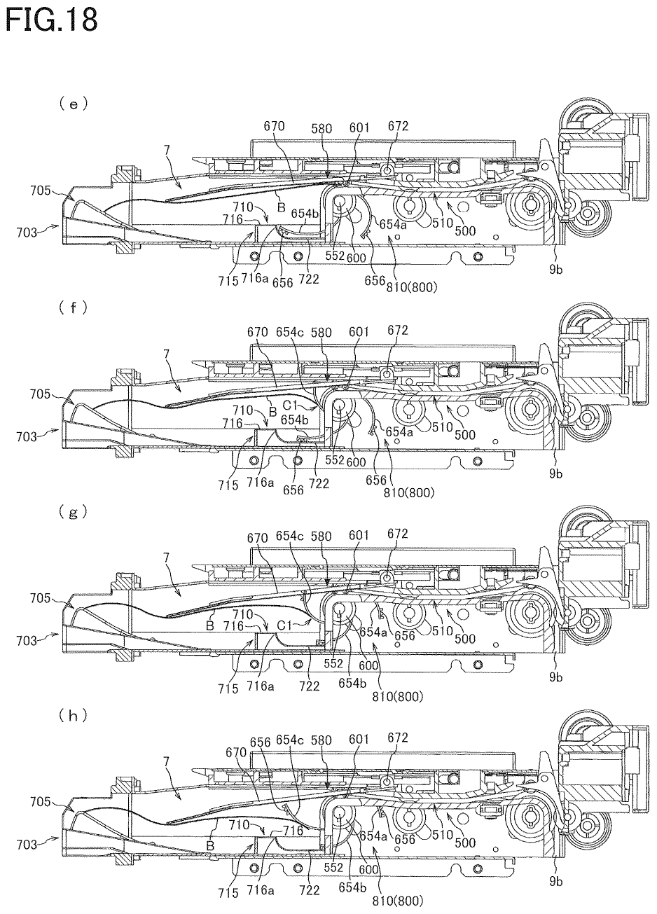

When a banknote having an upward curling habit is discharged from the discharging mechanism 810, the banknote is emitted in a curled state onto the dispense tray as illustrated in FIG. 18.

When a banknote is discharged onto the dispense tray by the drive rollers 555 and 600 and the tension rollers 556 and 601 (the last roller pairs), at a time of landing of a banknote having an upward curling habit on the dispense tray while being pressed by the lever 670, there is a risk that the leading end part downward curved interferes with the rear end part of an already-stacked banknote to push out the already-stacked banknote, or that the banknote drops out of the distal end of the dispense tray by its own weight.

In contrast thereto, in the present embodiment, in cooperation with the guide members provided in a protruded manner on the dispense tray and the stacking wheels, an appropriate place of the banknote immediately after emission, in this example, the rear part of the banknote is trapped to block excessive advance (retreat the banknote). Therefore, dropping of the banknote from the dispense tray by its own weight can be prevented. Furthermore, banknotes once stacked are held down at the rear part on the guide members and are prevented from advancing by the blades successively rotationally moving. Therefore, the banknotes are prevented from being pushed out by the following banknote.

According to the present embodiment, in the discharge transport stacking unit 800 including the discharging mechanism 810 having the function to only discharge a banknote onto the dispense tray without forming the short side shape of the banknote to correct a curling habit, the trouble that a discharged banknote jumps out and drops out of the dispense tray or pushes out an already-stacked banknote can be overcome only by replacing an existing dispense tray including no guide members with the dispense tray including the guide members.

### <Drawing Operation Performed by Discharge Transport Stacking Unit>

A banknote drawing operation performed by the discharge transport stacking unit 800 according to the third embodiment is explained below with reference to FIGS. 17 to 20.

FIGS. 17(a) to 17(d) are operation explanatory diagrams (lateral vertical sectional views) of the discharge transport stacking unit 800 illustrating states from when the leading end of a banknote B discharged and transported in the discharge transport route and having an upward curling habit abuts the lever and immediately after the leading end of a banknote has passed through the discharging mechanism 810 while the banknote is pushing up the lever.

FIGS. 18(e) and 18(f) are operation explanatory diagrams (lateral vertical sectional views) of the discharge transport stacking unit 800 illustrating a state immediately before the rear end of a banknote B passes through the discharging mechanism and a state immediately after the passing, and FIGS. 18(g), 18(h), 19(i) to 19(l), and 20(m) to 20 (o) are explanatory diagrams of a process until a banknote falls on the dispense tray and an operation procedure performed by blades to draw a banknote backward.

Since a processing procedure in FIGS. 17(a) to 17(d), 18(e), and 18(f) has no difference from that in FIGS. 11(a) to 11(d), 12(e), and 12(f), explanations thereof are simplified.

A processing procedure in FIGS. 18(g), 18(h), 19(i) to 19(l), and 20(m) to 20(o) has no difference from that in FIGS. 12(g), 12(h), 13(i) to 13(l), and 14(m) to 14(o) in the first embodiment except that the front part and the rear part of a discharged banknote are curved downward because the banknote is curled upward. Therefore, redundant explanations are reduced and differences are mainly described. Therefore, the redundant parts of which the explanations are omitted should be understood with reference to the corresponding descriptions in the first embodiment.

In FIG. 17(a), a banknote B transported on the discharge transport route 510 is brought into contact with the lower surface of the lever 670 and starts pressing the lower surface at a position immediately before the nip parts n1 of the last roller pairs. Since the lever shaft 672 is located behind the rotation shaft 552, the leading end part of the banknote is brought into contact with the lever at a position upstream from the rotation shaft and starts pushing up the lever. Furthermore, a sufficiently long distance L3 is provided between the lever shaft and the contact point C and the initial angle θ of the lever is set at a large value close to 180 degrees. Therefore, the banknote can start pushing up the lever with a small force (FIGS. 17(b) and 17(c)). Since the leading end of the banknote having a downward curved habit is provided with a high stiffness in the discharge transport route 510 and the curling habit is temporarily corrected similarly in the first embodiment, the lever can be pushed up.

At a time when the banknote passes the discharging mechanism 810, the banknote passes the nip parts n1 between the drive roller 555, 600 and the tension roller 555, 601.

In FIG. 17(d), the leading end of the banknote starts being protruded from the nip parts n1 and the lever is pressed by the banknote to be further pushed up. The downward curved habit returns on the leading end part of the banknote immediately after being discharged from the nip parts n1. However, since the lever can be pushed up with a small force from the reasons described above, the banknote can push up the lever with a small force without bowing thereto.

In FIG. 18(e), the front portion of the banknote except for the rear part nipped by the nip parts n1 between the drive rollers and the associated driven rollers is curled downward. However, the lever 670 is configured in such a manner that it can be pushed up with a small force. Accordingly, the banknote can continue to push up the lever as illustrated. Although the height position of the lever at that time is not the maximum height in the movable range of the lever, the banknote pushes up the lever as high as possible. That is, the banknote is discharged along the lower surface of the lever that is pushed up to the illustrated height position and the leading end of the banknote is in contact with the upper surface of the dispense tray (the upper surfaces 705a of the retractable members).

FIG. 18(f) illustrates a state where the rear end of the banknote B has completely passed through the discharging mechanism 810. Since the freed banknote is not formed in a straight shape unlike in the first embodiment, a contact part with the distal end part of the lever 670 is pressed downward to be deformed in a concave shape at this stage as illustrated in FIG. 18(f). Since this banknote has momentum of being emitted in the discharge direction, the banknote attempts to be discharged along the lower surface of the lever in a case where the stacking wheels and the guide members 710 are not provided. Accordingly, the banknote is likely to be brought into contact with an already-stacked banknote and push the already-stacked banknote to be dropped, or to drop by itself from the distal end of the dispense tray.

Next, at stages in FIGS. 18(g) and 18(h), the rear part of the banknote having left the nip parts n1 of the last roller pairs returns to the original shape that is curled downward. The leading end of the banknote is protruding from the distal end of the dispense tray in a state of being curved downward. If this state is left untreated, the banknote may drop from the distal end of the dispense tray. Particularly in a case where the length of the dispense tray in the front-back direction is reduced more, the emitted banknote is likely to be greatly protruded from the front end edge of the dispense tray having the shortened distal end and to drop when the banknote lands on the dispense tray while being pressed by the lever.

To overcome this trouble, in the present invention, the device is configured to sweep the banknote backward while blocking advance of the banknote in cooperation with the blades 654 of the stacking wheels and the guide members 710 after the point of time when the rear end part of the banknote has left the nip parts n1 as illustrated in FIGS. 18(g) and 18(h).

That is, each of the guide members 710 as projections is fixedly arranged at a position corresponding the movement trajectory of the blades 654 of the associated stacking wheel on the upper surface of the dispense tray corresponding to the space 702 for retreat provided in the back of the dispense tray 700. With retreat of the banknote B temporarily discharged onto the dispense tray toward the space 702 by a cooperative operation with the guide members and the stacking wheels, the state where the leading end of the banknote is protruded from the distal end edge of the dispense tray is eliminated.

The arrangement and the height of the guide members 710 are configured to enable sweeping by the blades to be started at a stage where the rear part of a banknote being falling on the dispense tray is in the air before falling on the upper surfaces 716 or the rear end edges 716a of the guide members as illustrated in FIGS. 18(g) and 18(h). That is, the arrangement and the height of the guide members are configured to cause a first contact between a falling banknote and blades to be made at a point of time when the banknote is in the air (a point of time in FIG. 18(f) or 18(g)).

Due to variation in the behavior of banknotes, the rear part of a banknote may be brought into contact with the distal ends of blades after the banknote rear part has fallen on the upper surfaces of the guide members or at the same time of the falling. However, it is confirmed that the banknote can be swept backward also in this case without any problem.

The lengths and the positional relation of the blades 654 are set to be always brought to sliding contact with the outer surface of the associated guide member 710 in the process of rotational moving.

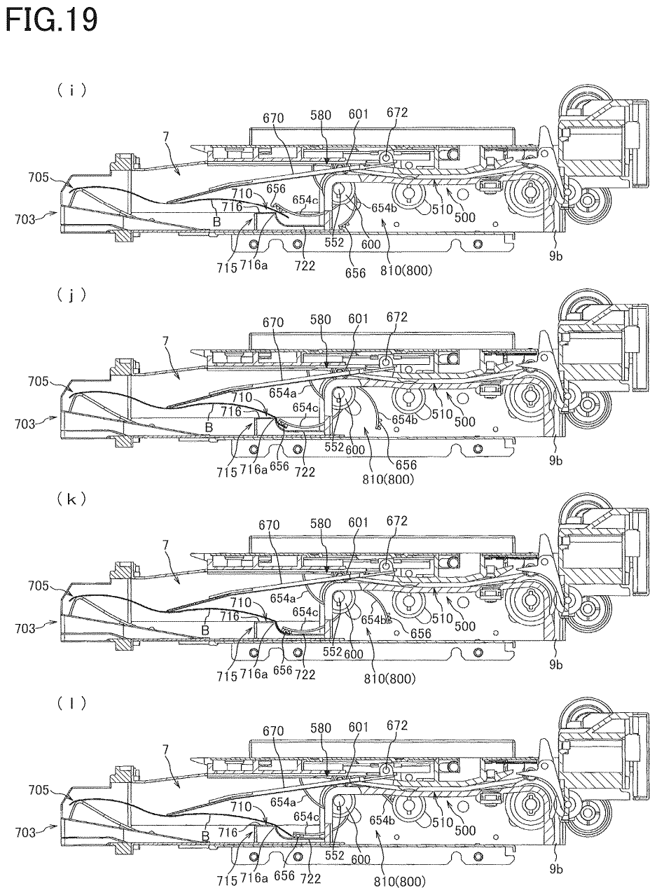

The rotation speed of the stacking wheels, the rotation timing of the blades with respect to a discharge banknote, and the lengths of the blades (the rotation trajectory of the blade ends) are selected to enable the curved rear part of a banknote discharged onto the dispense tray to be trapped by blades 654c rotationally moving from above and to be pulled downward toward the guide member 710 as illustrated in FIGS. 18(g), 18(h), 19(i) and 19(j).

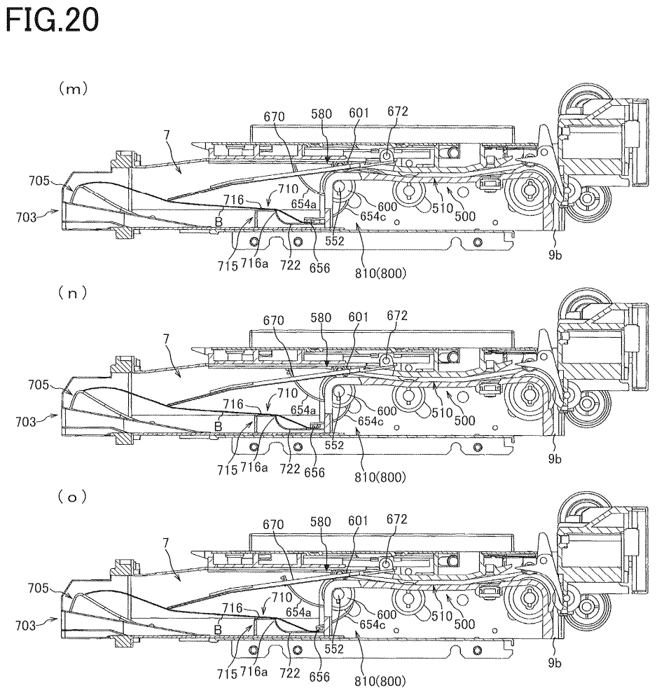

With this configuration, even when a discharged banknote is being excessively protruded forward, blades 654c can trap the rear end of the banknote in the air and start sweeping the banknote downward and backward at an early moment when the banknote rear part is being discharged. Furthermore, at a point of time when blades 654c have reached the rear end edges 716a of the guide members, the blades can start nipping the rear part of the banknote with the rear end edges and then draw the entire banknote backward while nipping the banknote between the distal ends of the blades and the curved guide surfaces 720 (FIGS. 19(k), 19(l) and 20(m) to 20(o)).

Furthermore, similarly in the first embodiment, by appropriate selecting or setting the contact timing between the blades and each banknote, in other words, the rotation speed of the blades and the emitting speed of banknotes, the operation of forcibly drawing a banknote in the lowering direction and toward the back can be started at a point of time when the banknote rear part being in the air is brought into contact with blades. Subsequently, at a point of time when the blades are lowered to a position where the blades are in contact with the upper surfaces of the guide members and the rear end edges thereof, the banknote rear part is in a state of being nipped between the blades and the guide members. Therefore, the banknote is reliably pulled backward along the curved guide surfaces 720 by the subsequent rotating operation of the blades. Accordingly, all banknotes are stacked in a state where the rear ends are aligned on the dispense tray regardless of differences in the size in the long edge direction, and are prevented from dropping from the distal end edge of the dispense tray.

In the present embodiment, a banknote being discharged onto the dispense tray is pulled backward after the leading end part is caused to temporarily land on the dispense tray (on the retractable members 705) as illustrated in FIGS. 18(g) to 20(o). When this phenomenon is seen from the side of the return port, the banknote acts to be temporarily discharged in a state of being protruded from the front end edge of the dispense tray and to be pulled backward immediately thereafter and stop.

Since the curling habit returns on banknotes discharged from the discharging mechanism 810, there is a risk that the falling routes or the falling timings vary. Therefore, the blades cannot always trap the banknote rear parts in the air at the same timing. The banknote rear part may fall on the guide members before blades are brought into contact therewith. However, according to the present embodiment, the blades can sweep the banknote backward by nipping the banknote rear part with the guide members also in this case.

More specifically, since a banknote being discharged from the discharging mechanism 810 has a curling habit, the curling habit returns at the moment when the banknote has passed through the discharging mechanism, the banknote rear end is curled up away from the blades, and the banknote rear part may fall on the guide members 710 before being brought into contact with the blades. However, also in this case, according to the configuration of the present embodiment, the banknote rear part is caught on the guide members to be blocked from moving forward, and is trapped by the distal ends of subsequently lowered blades to be swept backward. As a result, dropping of the banknote from the dispense tray is prevented.

In light of the above configurations and functions of the stacking wheels 650, the lever 670, the guide members 710, and the like, an operation of the stacking wheels to draw a banknote discharged from the discharging mechanism 810 backward in the process in which the lever pushes the banknote downward is further explained next.

As illustrated in FIGS. 18(g) and 18(h), when blades 654c rotating downward are brought into contact with the rear part of a banknote B being discharged from the discharge mechanism 810 onto the dispense tray while the banknote rear part is still in the air, the blades reliably trap the banknote and start an operation to forcibly sweep the banknote downward and backward in cooperation with the pressing-down operation of the lever. That is, since the banknote discharged from the discharging mechanism 810 is biased forward, the banknote is attempting to move toward the distal end edge of the dispense tray 700 in the air. By bringing blades 654c moving downward with respect to the rear part of the banknote being in the air illustrated in the drawings into contact with the banknote, momentum of the banknote to advance can be reduced to stop the movement in the advancing direction, and the banknote can be further guided to the direction (downward and backward) in which the blades 654c rotationally move.

When the blades 654c trap the rear part of the banknote B in the air and then continue the downward rotation in FIGS. 18(g) and 18(h), the blades 654c press down the banknote rear part until the rear part is brought into contact with the upper surfaces 716 and the rear end edges 716a of the guide members 710 as illustrated in FIGS. 19(i) and 19(j). At that time, the banknote rear part is in a state of being compressively held between the lower surfaces (the high friction regions 656) of the blades 654c and the rear end edges 716a. Therefore, with further continuation of the rotational movement of the blades, the banknote moves backward along the curved guide surfaces 720 and the rear part guide surfaces 722.

At the point of time in FIG. 20(o), the blades 654c are almost separate from the banknote rear end and the backward movement of the banknote accordingly stops. A stopper for aligning the rear ends of banknotes swept to the back may be provided at the terminal end part of the space 702 for retreat as required.

As described above, at an earlier timing than falling (contacting) of the rear part of a banknote being discharged from the discharging mechanism 810 on the rear end edges 716a, the blades 654c are brought into contact with the banknote rear part at a position forward and upper than the rear end edges 716a and start sweeping the banknote to be returned downward and backward (in the opposite direction to the emitting direction of banknotes). In other words, the contact position (first contact position) Cl between blades and a banknote can be set to a farther position on the rotation trajectory of the blades. Accordingly, backward sweeping of a banknote can be started at an early stage before the banknote has completely landed on the dispense tray and therefore the processing speed of banknote stacking can be increased.

Furthermore, due to provision of the guide members 710, the rear part of a banknote while falling can be brought into contact with the rear end edges 716a of the guide members when the rear part is at an upper position than the upper surface 701 of the dispense tray. That is, the banknote rear part can be caught on the rear end edges 716a at an early timing before the banknote rear part lands on the dispense tray. Therefore, a banknote that has temporarily landed on the dispense tray in a state of being protruded from the front end edge of the dispense tray can be promptly swept backward and can be stopped at an optimum position. Particularly in the case of a crumpled banknote, backward sweeping sometimes cannot be sufficiently performed only by holding the banknote with blades when the banknote is discharged onto the dispense tray. Accordingly, a point where the blades are brought into contact with a banknote is set in the air and the banknote is drawn in cooperation with the guide members, whereby sweeping processing of a crumpled banknote can be performed reliably.

According to the configuration described above, since the rear ends of all banknotes discharged onto the dispense tray can be sequentially aligned regardless of the sizes of the banknotes in the long edge direction, a plurality of banknotes stacked on the dispense tray can be set to an optimum state for a user to take out the banknotes collectively while the banknotes are prevented from being excessively protruded from the distal end edge of the dispense tray or dropping.

There is a strong request to downscale and shorten the dispense tray as much as possible and this request can be met because the rear ends of discharged banknotes can be aligned with respect to the back part of the dispense tray.

As described above, according to the present embodiment, the trouble that the leading end of a banknote is likely to slip out of the dispense tray beyond the front end edge by its own weight due to momentum at the emission from the discharging mechanism 550 can be overcome. Furthermore, since the stacking wheel blades rotationally moving without any interruption hold the rear parts of already-stacked banknotes with the guide members, the trouble that the following banknote pushes out the already-stacked banknotes is also overcome.

### Summary of Configurations, Actions, and Effects of Present Invention

### First Invention (First and Second Embodiments)

The paper sheet discharge stacking device M2 according to a first aspect of a first invention is means for successively discharging paper sheets dispensed from the circulation unit 30, 40 storing transported paper sheets and dispensing stored paper sheets to outside, one by one onto the discharge tray 700 with a short side of the paper sheet at a head and for stacking the discharged paper sheets, and includes the discharge transport route 510 on which the paper sheets are transported to the discharge tray, and the forming mechanism 550 that forms a short side shape (a shape of a side extending in a direction intersecting with a transport direction) of each of the paper sheets transported on the discharge transport route into a predetermined shape (a shape to increase the stiffness) across an entire length in a long edge direction and that discharges the formed paper sheet onto the dispense tray.

In the forming operation of the forming mechanism 550, upward protruded parts (bent parts protruded upward) and downward protruded parts (bent parts protruded downward) are alternately formed along a short side direction of the paper sheets and the both end parts S2 of short sides of each of the paper sheets are inclined upward (protruded obliquely upward).

In a paper sheet processing device for banknotes or the like, requests for a circulation machine are increased. When a plurality of banknotes are to be dispensed, configuring the paper sheet processing device in such a manner that the banknotes are successively dispensed one by one onto the discharge tray, and that a user can take out the banknotes after stacking of all the banknotes is completed is desirable to increase the processing speed.

In conventional devices of a type that dispenses banknotes one by one, unless a user takes out a dispensed banknote, the following banknote is not dispensed. Therefore, a long time is required to dispense all banknotes. However, even when a dispensed banknote is curled, a problem of hit against an already-stacked banknote does not occur. In conventional devices, when ten banknotes are dispensed, a required time per banknote is normally 2 seconds although it depends on the operating time required for a user to take out banknotes.

On the other hand, when banknotes are taken out collectively after the banknotes are successively discharged one by one onto the discharge tray and are stacked thereon, the required time per banknote at the time of dispense of ten banknotes can be reduced to 1.5 seconds while the discharge speed of banknotes is the same as that in the conventional devices.

When banknotes are successively stacked, a problem of hit against existing banknotes newly occurs. However, the problem of hit against existing banknotes is solved by simple specifications.

That is, in the present invention, occurrence of a discharge failure or a stacking failure (pushing of preceding banknotes, a misaligned stacking state, variation in its own stop position, drop, and the like) on the discharge tray due to a curling habit formed on a banknote can be prevented. Furthermore, in addition to a curling habit, a discharge failure or a stacking failure resulting from deformation such as a crease or a wrinkle formed on a banknote, or decrease in the stiffness can be eliminated.

The both end parts S2 and S2 of the short side of a banknote are positioned above the downward protruded parts P2, and hit against already-stacked banknotes can be avoided. The possibility of the hit can be further decreased by maintaining the height of the upward protruded parts P3 on the both end parts at a position substantially the same as that of the upward protruded part P1 at the center, or higher.

In the paper sheet discharge stacking device M2 according to a second aspect, the short side shape of each of the paper sheets after forming of the paper sheet by the forming mechanism 550 is a substantially bilaterally symmetrical shape.

In the short side shape of a paper sheet after the forming by the forming mechanism, it suffices that the both end parts are retracted upward. However, a bilaterally symmetrical shape is preferable in view of stability in seating in the process of being discharged onto the discharge tray or after the discharge, the handling performance of users, and the like.

In the paper sheet discharge stacking device M2 according to a third aspect, the short side shape of each of the paper sheets after forming of the paper sheet by the forming mechanism 550 is a substantially W shape.

In the short side shape of a paper sheet after the forming by the forming mechanism, it suffices that the both end parts are retracted upward. However, a substantially W shape including the upward protruded part P1 at the center and including the downward protruded parts P2 on both right and left sides thereof is highly practical because the number of components of the forming mechanism can be reduced and the forming mechanism can be downscaled.

In the paper sheet discharge stacking device M2 according to a fourth aspect, the forming mechanism 550 includes at least the rotation shaft 552 that is arranged orthogonally to a transport direction of the paper sheets and that is rotationally driven in a discharge direction, the central flange 605 that has an axis fixed to the rotation shaft, two roller pairs constituted of the two drive rollers 555 and 600 that are respectively arranged with a predetermined interval from both sides of the central flange in an axial direction and that each have an axis fixed by the rotation shaft, and the driven rollers 556 and 601 that each form the nip part n1 for paper sheet transport with an associated one of the drive rollers, and the outer flanges 607 and 609 that are respectively arranged on outer sides of the two drive rollers in the axial direction and that each have an axis fixed to the rotation shaft.

A conventional discharge mechanism that dispenses paper sheets onto a dispense tray is constituted of roller pairs each including a drive roller and a driven roller. Meanwhile, the present invention has a configuration in which only three flanges are added to the conventional discharge mechanism. Simplification and downscaling of the configuration can be realized by reducing the number of components to the minimum necessary. While the space of a void E for storage is limited, design with margin can be realized with this configuration.

The paper sheet discharge stacking device M2 according to a fifth aspect includes the paper sheet holding lever 670 that has a rear part supported about an axis by the lever shaft 672 arranged upstream from the rotation shaft 552 in the transport direction of the paper sheets and above the discharge transport route 510 to be pivotable in an upper-lower direction, and that has a front portion (a forward portion relative to the lever shaft) protruding on the discharge tray beyond the rotation shaft, in which the paper sheet holding lever includes a configuration to pivot up and down by an action of each of the paper sheets passing below the lever in a process in which the paper sheet passes the forming mechanism, and the paper sheet holding lever is arranged at an axial position interfering with the central flange 605 and includes the opening part 673 in a portion of the paper sheet holding lever interfering with the central flange to allow pivot in an upper-lower direction while avoiding the central flange.

The lever shaft is located upstream from the rotation shaft 552 and the lever front portion is protruded forward beyond the rotation shaft. Accordingly, the lever becomes long and the initial angle θ at the lowered time is increased, so that the lever can be easily pushed up at the time of entry of a paper sheet.

In the paper sheet discharge stacking device M2 according to a sixth aspect, a part of the paper sheet holding lever 670 interferes with the discharge transport route when the paper sheet holding lever is lowered.

A place where a paper sheet is brought into contact with the lever and starts pushing up the lever is in the discharge transport route 510 upstream from the forming mechanism 550. Since the distance to the lever shaft from the contact part C between the lever and the paper sheet leading end can be shortened, the lever can be more easily pushed up by a paper sheet.

The paper sheet discharge stacking device M2 according to a seventh aspect is configured to block a part of a paper sheet from sinking in between both inner edges of the opening part 673 of the paper sheet holding lever 670 and both outer surfaces of the central flange 605.

In other words, the width of the central flange is configured to block sinking of a part of a paper sheet in the gaps G2 formed between the both inner edges of the opening part and the both outer surfaces of the central flange.

A paper sheet having a greatly decreased stiffness (a crumpled paper sheet) may be buckled without sufficiently pushing up the paper sheet holding lever after being discharged from the forming mechanism. A cause thereof is as follows. Since the gaps between the central flange and the opening part of the paper sheet holding lever are too large, a part of a paper sheet sinks in the gaps to decrease the stiffness, and a force to push up the paper sheet holding lever is decreased.

In the present invention, sinking of a part of a crumpled paper sheet into the gaps can be prevented by sufficiently increasing the width of the central flange to eliminate the gaps or reduce the gaps, and the paper sheet can be supported by the outer circumferential surface of the central flange to maintain an upturned attitude to prevent from bowing to the paper sheet holding lever.

In the paper sheet discharge stacking device M2 according to an eighth aspect, the discharge tray 700 includes the base surface 701, the protruded parts 703 that are respectively provided to be protruded forward from both end parts of the base surface in a width direction and that each have the upward inclined surface 703a on the upper surface, the retractable members (inclined surface forming members) 705 that are each configured to enable a front part to pivot in the upper-lower direction by having a rear part supported about an axis in the groove or hole 704 provided at an inner edge part of each of the protruded parts, and an elastic member that biases the retractable members to an upper protruded position.

Since the retractable members are in a protruded state in normal times, the retractable members have a function to brake discharged paper sheets. However, the protruded retractable members obstruct to some extent a user when the user takes out paper sheets stacked on the discharge tray. Accordingly, the retractable members are configured in such a manner that a user can retreat the retractable members by pushing down the retractable members.

A circulation-type paper sheet processing device 1 according to a ninth aspect includes the inlet (deposit/dispense port) 5 for paper sheets; the introduction part 11 that receiving-transports (carries in) the paper sheets input from the inlet along a long edge direction of the paper sheets; the circulation unit 30, 40 that receives and stores the paper sheets, and that dispenses stored paper sheets to outside; and any of the paper sheet discharge stacking devices M2 described above, in which the circulation unit includes a circulation drum that stacks and stores paper sheets one by one on an outer circumferential surface by forwardly rotating, and that dispenses paper sheets on the outer circumferential surface one by one by reversely rotating.

This circulation-type paper sheet processing device includes all functions and advantages provided by the paper sheet discharge stacking devices M2 described above.

### Second Invention (Third Embodiment)

The paper sheet discharge stacking device M2 according to a first aspect of a second invention is means for discharging paper sheets dispensed from the circulation unit 30, 40 storing transported paper sheets and dispensing stored paper sheets to outside, one by one onto the discharge tray 700 with a short side of the paper sheet at a head and for stacking the discharged paper sheets, and includes the discharge transport route 510 on which the paper sheets are transported to the discharge tray, the last discharging mechanism 810 located downstream of the discharge transport route, the discharge tray 700 on which paper sheets discharged from the last discharging mechanism are stacked, and the paper sheet holding lever 670 that has a rear part supported about an axis to be pivotable in an upper-lower direction and that has a front portion protruding on the discharge tray to hold the paper sheets discharged from the last discharging mechanism.

The last discharging mechanism 810 includes the rotation shaft 552 that is arranged orthogonally to a transport direction of the paper sheets and that is rotationally driven in a discharge direction, and last roller pairs constituted of at least the two drive rollers 555 and 600 that each have an axis fixed to the rotation shaft, and the driven rollers 556 and 601 that each form the nip part n1 for paper sheet transport with an associated one of the drive rollers.

The stacking wheel 650 that has an axis fixed to the rotation shaft is included on an outer side of each of the drive rollers in the axial direction. Blades constituting each of the stacking wheels include a movement trajectory to be brought into contact with a banknote discharged from the last discharging mechanism and to push the banknote down in a process of rotating downward toward an upper surface of the discharge tray, and the guide protruded part (the guide member) 710 that interferes with the blades and allows rotational movement (passing) of the blades while elastically deforming the blades is provided on the discharge tray upper surface interfering with the movement trajectory of the blades. The guide protruded part includes the first contact part 716, 716a that is brought into contact with a rear part of a paper sheet discharged by the last discharging mechanism (the last roller pairs) onto the dispense tray at a position higher than the dispense tray upper surface (in prior to the dispense tray upper surface), and the (curved) guide surface 720 that extends downward (to be curved) from the first contact part to the back (to the upstream side) in the discharge direction.

Since the first contact part is at a position where the distal end part of each blade rotationally moving is brought into contact therewith, the distal end part of each blade passes while being elastically deformed and being in contact with the first contact part. To enable a paper sheet to be swept backward by cooperation with the blades, the shapes and the positional relations of the curved guide surface 720 and the rear part guide surface 722 are also selected to cause the distal end part of each blade to move while being elastically deformed and being in contact therewith.

In the paper sheet discharge stacking device M2 according to a second aspect, a movement trajectory of the blades is set and matching with discharge timings of paper sheets is provided to enable a first contact between the blades and each of the paper sheet to be made at a point of time when a rear part of the paper sheet is in the air.

By trapping of a paper sheet with blades and starting sweeping of the paper sheet with the blades at an early time after the rear end of the paper sheet leaves the last discharging mechanism, that is, during a period in which the paper sheet rear end is in the air, it is possible to reliably prevent a paper sheet from jumping and dropping out of the distal end of the discharge tray.

In the paper sheet discharge stacking device M2 according to a third aspect, in a process in which the blades 654 are brought into contact with the rear part of the paper sheet at a position upper than the first contact part and then rotationally move downward and backward, a paper sheet portion being in contact with the blades sequentially moves through the first contact part to the curved guide surface 720 along with the blades.

By matching the discharge timing of a paper sheet with the moving timing of blades to bring the blades into contact with the paper sheet rear part at an upper position than the first contact part, that is, in the air, the backward sweeping operation can be started early. As a result, the paper sheet rear part can be brought into contact with the first contact part of the guide member early to continue prompt backward sweeping.

In the paper sheet discharge stacking device M2 according to a fourth aspect, the paper sheet holding lever 670 has a rear part supported about an axis by the lever shaft 672 arranged upstream from the rotation shaft 552 in the transport direction of the paper sheets and above the discharge transport route 510 to be pivotable in an upper-lower direction, and has a front portion protruding onto the discharge tray beyond the rotation shaft.

Since the lever shaft provided at a base end part of the paper sheet holding lever is arranged upstream from the last discharge mechanism, the stiffness of a paper sheet having a habit such as a curling habit and transported in the discharge transport route is temporarily increased and the paper sheet can push up the paper sheet holding lever with a small force. The stacking wheels and the guide protruded parts can realize control of the falling route of banknotes and backward sweeping thereof by cooperation with the paper sheet holding lever.

In the paper sheet discharge stacking device M2 according to a fifth aspect, the discharge tray 700 includes the base surface 701, the protruded parts 703 that are respectively provided to be protruded forward from both end parts of the base surface in a width direction and that each have the upward inclined surface 703a on an upper surface, the retractable members (inclined surface forming members) 705 that are each configured to enable a front part to pivot in an upper-lower direction by having a rear part supported about an axis in the groove or hole 704 provided at an inner edge part of each of the protruded parts, and an elastic member that biases the retractable members to an upper protruded position.

Since the retractable members are in a protruded state in normal times, the retractable members have a function to brake discharged paper sheets. However, the protruded retractable members obstruct to some extent a user when the user takes out paper sheets stacked on the discharge tray. Accordingly, the retractable members are configured in such a manner that a user can retreat the retractable members by pushing down the retractable members.

A circulation-type paper sheet processing device according to a sixth aspect includes the inlet (deposit/dispense port) 5 for paper sheets; the introduction part 11 that receiving-transports (carries in) the paper sheets input from the inlet along a long edge direction of the paper sheets; the circulation unit 30, 40 that receives and stores the paper sheets and that dispenses stored paper sheets to outside; and any of the paper sheet discharge stacking devices M2 described above, in which the circulation unit includes a circulation drum that stacks and stores paper sheets one by one on an outer circumferential surface by forwardly rotating, and that dispenses paper sheets on the outer circumferential surface one by one by reversely rotating.

This circulation-type paper sheet processing device includes all functions and advantages provided by the paper sheet discharge stacking devices M2 described above.

Reference Signs List

1 . . . banknote processing device, 3 . . . housing, M . . . deposit/dispense processing
unit. M1 . . . first unit, M2 . . . second unit (paper sheet discharge stacking device, collective
dispensing unit), 5 . . . inlet/outlet (input port), 7 . . . dispense port (discharge port),
B . . . dispense banknote, P1, P2, P3 . . . protruded part, 9a . . . deposited banknote transport
route, 9b . . . storage banknote transport route, 9c . . . in-casing transport route,
11 . . . collective deposit unit (introduction unit), 15 . . . recognition unit, 30, 40 . . . circulation-
type banknote storage unit (circulation unit), 31, 35, 41, 45 . . . circulation drum,
50 . . . collection container, 60 . . . casing, 61 . . . first distribution unit, 65 . . . second distribution
unit, 65a . . . distribution piece, 100 . . . circulation unit, 105, 110 . . . bobbin, 106a . . . guide
roller, 111a . . . guide roller, 200 . . . circulation unit, 310 . . . flapper, 500 . . . discharge transport
stacking unit, 510 . . . discharge transport route, 510a . . . transport guide, 512a . . . roller,
514 . . . flapper, 517 . . . transport roller, 520 . . . discharge transport mechanism,
550 . . . forming mechanism, 552 . . . rotation shaft, 555, 600 . . . drive roller, 556,
601 . . . tension roller, 562 . . . base part, 580 . . . tracking sensor, 605 . . . central flange, 607,
609 . . . outer flange, 650 . . . stacking wheel, 652 . . . base part, 654 . . . blade, 656 . . . high
friction region, 656a . . . convex part, 656b . . . concave part, 660 . . . frame, 670 . . . lever,
670a . . . branch part, 672 . . . lever shaft, 673 . . . opening part, 675 . . . weight member,
700 . . . dispense tray (discharge tray), 701 . . . base surface (first upper surface), 702 . . . space,
703 . . . protruded part, 703a . . . inclined surface (second upper surface), 704 . . . groove (hole),
705 . . . retractable member (inclined surface forming member), 705a . . . upper surface,
710 . . . guide member (guide protruded part), 715 . . . front protruded part, 716 . . . upper
surface, 716a . . . rear end edge, 720 . . . curved guide surface, 722 . . . rear part guide surface,
800 . . . discharge transport stacking unit, 810 . . . last discharging mechanism,
1000 . . . control unit.

1. A paper sheet discharge stacking device that discharges paper sheets dispensed from a circulation unit storing transported paper sheets and dispensing stored paper sheets to outside, one by one onto a discharge tray with a short side of the paper sheet at a head and that stacks the discharged paper sheets, comprising:
a discharge transport route on which the paper sheets are transported to the discharge tray; and a forming mechanism that forms a short side shape of each of the paper sheets transported on the discharge transport route into a predetermined shape across an entire length in a long edge direction and that discharges the formed paper sheet onto the discharge tray, wherein
upward protruded parts and downward protruded parts are alternately formed along a short side direction of the paper sheets and both end parts of short sides of each of the paper sheets are inclined upward in the forming by the forming mechanism.

2. The paper sheet discharge stacking device according to claim 1, wherein the short side shape of each of the paper sheets after forming of the paper sheet by the forming mechanism is a substantially bilaterally symmetrical shape.

3. The paper sheet discharge stacking device according to claim 1, wherein the short side shape of each of the paper sheets after forming of the paper sheet by the forming mechanism is a substantially W shape.

4. The paper sheet discharge stacking device according to claim 1, wherein the forming mechanism comprises at least a rotation shaft that is arranged orthogonally to a transport direction of the paper sheets and that is rotationally driven in a discharge direction, a central flange that has an axis fixed to the rotation shaft, two roller pairs constituted of two drive rollers that are respectively arranged with a predetermined interval from both sides of the central flange in an axial direction and that each have an axis fixed by the rotation shaft, and driven rollers that each form a nip for paper sheet transport with an associated one of the drive rollers, and outer flanges that are respectively arranged on outer sides of the two drive rollers in the axial direction and that each have an axis fixed to the rotation shaft.

5. The paper sheet discharge stacking device according to claim 4, comprising
a paper sheet holding lever that has a rear part supported about an axis by a lever shaft arranged upstream from the rotation shaft in the transport direction of the paper sheets and above the discharge transport route to be pivotable in an upper-lower direction, and that has a front portion protruding on the discharge tray beyond the rotation shaft, wherein
the paper sheet holding lever includes a configuration to pivot up and down by an action of each of the paper sheets passing below the lever in a process in which the paper sheet passes the forming mechanism, and
the paper sheet holding lever is arranged at an axial position interfering with the central flange and includes an opening part in a portion of the paper sheet holding lever interfering with the central flange to allow pivot in an upper-lower direction while avoiding the central flange.

6. The paper sheet discharge stacking device according to claim 5, wherein a part of the paper sheet holding lever interferes with the discharge transport route when the paper sheet holding lever is lowered.

7. The paper sheet discharge stacking device according to claim 5, configured to block a part of a paper sheet from sinking in between both inner edges of the opening part of the paper sheet holding lever and both outer surfaces of the central flange.

8. The paper sheet discharge stacking device according to claim 1, wherein the discharge tray includes a base surface, inclined protruded parts that are respectively provided to be protruded forward from both end parts of the base surface in a width direction and that each have an upward inclined surface on an upper surface, retractable members that are each configured to enable a front part to pivot in an upper-lower direction by having a rear part supported about an axis in a groove or hole provided at an inner edge part of each of the inclined protruded parts, and an elastic member that biases the retractable members to an upper protruded position.

9. A circulation-type paper sheet processing device comprising:
an inlet for paper sheets;
an introduction part that receiving-transports the paper sheets input from the inlet along a long edge direction of the paper sheets;
a circulation unit that receives and stores the paper sheets, and that dispenses stored paper sheets to outside; and
a paper sheet discharge stacking device that discharges paper sheets dispensed from the circulation unit, one by one onto a discharge tray with a short side of the paper sheet at a head and that stacks the discharged paper sheets, comprising:
a discharge transport route on which the paper sheets are transported to the discharge tray; and a forming mechanism that forms a short side shape of each of the paper sheets transported on the discharge transport route into a predetermined shape across an entire length in a long edge direction and that discharges the formed paper sheet onto the discharge tray,
wherein upward protruded parts and downward protruded parts are alternately formed along a short side direction of the paper sheets and both end parts of short sides of each of the paper sheets are inclined upward in the forming by the forming mechanism,
wherein the circulation unit includes a circulation drum that stacks and stores paper sheets one by one on an outer circumferential surface by forwardly rotating, and that dispenses paper sheets on the outer circumferential surface one by one by reversely rotating.

10. The paper sheet discharge stacking device according to claim 6, configured to block a part of a paper sheet from sinking in between both inner edges of the opening part of the paper sheet holding lever and both outer surfaces of the central flange.
